(19) United States
(12) Patent Application Publication
(10) Pub. No.: US 2024/0415241 A1
(43) Pub. Date: Dec. 19, 2024

(54) Connecting Device

(71) Applicant: Fidlock GmbH, Hannover (DE)

(72) Inventors: David Richter, Hannover (DE); Joachim Fiedler, Hannover (DE); Breido Botkus, Hannover (DE)

(21) Appl. No.: 18/703,918

(22) PCT Filed: Nov. 21, 2022
(86) PCT No.: PCT/EP2022/082639

§ 371 Date: Apr. 23, 2024

(30) Foreign Application Priority Data
Nov. 30, 2021 (DE) 10 2021 213 558.7

(51) Int. Cl. A44B 11/25

(52) U.S. Cl. CPC A44B 11/2588; A44D 2200/10; A44D 2203/00

(57) ABSTRACT

Provided is a connecting device includes a first connecting part which includes a first base body and at least one engagement protrusion arranged rigidly on the first base body, and a second connecting part, which can be attached to the first connecting part in a closing direction and includes a second base body with an engagement section arranged rigidly on the second base body. The first connecting part includes a first magnetic device and the second connecting part includes a second magnetic device. The first magnetic device and the second magnetic device interact in a magnetically attracting manner along the closing direction to support the attachment of the first connecting part and the second connecting part to one another. The first connecting part includes a blocking section which is configured to cooperate with the second connecting part in the connected position.

### CROSS-REFERENCE TO RELATED APPLICATIONS

This application is the United States national phase of International Patent Application No. PCT/EP2022/082639, filed Nov. 21, 2022, and claims priority to German Patent Application No. 10 2021 213 558.7, filed Nov. 30, 2021, the disclosures of which are hereby incorporated by reference in their entireties.

### BACKGROUND

### 1. Technical Field

This disclosure relates to a connecting device.

### 2. Technical Considerations

An existing connecting device includes a first connecting part which comprises a first base body and at least one engagement protrusion arranged rigidly on the first base body. The connecting device also comprises a second connecting part which can be placed against the first connecting part in a closing direction and which comprises a second base body with an engagement section arranged rigidly on the second base body, wherein the engagement section can be brought into engagement with the at least one engagement protrusion of the first connecting part along an engagement direction which is different from the closing direction, so that the engagement section is in engagement with the at least one engagement protrusion of the first connecting part in a connected position of the first connecting part and the second connecting part. The first connecting part comprises a first magnetic device and the second connecting part comprises a second magnetic device. The first magnetic device and the second magnetic device cooperate in a magnetically attracting manner along the closing direction to support the placing of the first connecting part and the second connecting part against one another.

In the connecting device, one or more engagement protrusions are rigidly formed on the first base body of the first connecting part. The second connecting part can be brought into engagement with the at least one rigid engagement protrusion by bringing an engagement section of the second connecting part into engagement with the at least one engagement protrusion of the first connecting part. The first connecting part and the second connecting part are placed against one another along a closing direction, along which magnetic devices of the connecting parts provide a magnetic attraction force so that the connecting parts are attracted to one another along the closing direction. In contrast, the engagement of the engagement section of the second connecting part with the at least one engagement protrusion of the first connecting part is effected along an engagement direction that is transverse to the closing direction. In the connected position, the engagement section engages with the at least one engagement protrusion in a form-fit or force-fit manner, so that the connecting parts are held together.

In this case, the fact that the engagement direction is different from the closing direction means that the engagement direction is perpendicular or at an oblique angle to the closing direction. The engagement direction is not necessarily exactly perpendicular to the closing direction but can be at an oblique angle to the closing direction. However, the engagement direction is not directed along the closing direction and in particular also not in the direction opposite to the closing direction.

In a fastener device known from EP 3 616 553 A1 for detachably connecting two parts, a first connecting part can be placed against a second connecting part in order to connect the connecting parts to one another. A shoelace is arranged on one of the connecting parts which can be tightened by connecting the connecting parts to one another.

A fastener device is known from EP 3 192 388 B1, in which a first connecting part comprises a rigid engagement protrusion and can be connected to a second connecting part. A strap is adjustably arranged on the second connecting part.

In a connecting device of the type mentioned, it is generally desirable to enable the connecting parts to be connected in a simple, comfortable and haptically pleasant way for a user. The connection should preferably be made possible in a position-tolerant manner, with imprecise placing of the connecting parts against one another. In a connected position of the connecting parts, a secure, resilient connection should be obtained.

### SUMMARY

Provided is an improved connecting device in which the connecting parts can be placed against one another in a simple, convenient manner and provide a secure, resilient hold on one another in a connected position.

According to a non-limiting embodiment, provided is a connecting device where the first base body comprises a positive-locking section against which the second base body abuts in the connected position of the first connecting part and the second connecting part in order to counteract tilting of the second connecting part relative to the first connecting part, wherein the second base body abuts against the first base body in a first region in the connected position, in a second region, which adjoins the first region in the engagement direction, does not but against the first base body, so that a free space is formed between the first base body and the second base body when viewed along the closing direction, and a third region, which adjoins or is spaced apart from the second region in the engagement direction, is supported on the positive-locking section.

The first base body comprises a positive-locking section against which the second base body abuts in the connected position of the first connecting part and the second connecting part in order to counteract tilting of the second connecting part relative to the first connecting part. The positive-locking section is formed in particular in a front region of the first base body with respect to the engagement direction and is rigidly formed on the first base body. The second base body is supported on the positive-locking section, in particular against movement in the closing direction, so that tilting of the second connecting part relative to the first connecting part is at least made more difficult by the support on the positive-locking section.

In the connecting device, a load direction along which a load force acts on the second connecting part when loaded as intended in a loaded state can preferably be directed with at least one directional vector component in the engagement direction. In the loaded state, the second connecting part is thus loaded in the engagement direction relative to the first connecting part and thus in the engagement direction with the at least one engagement protrusion rigidly formed on the first connecting part.

Due to such a load, a torque can act on the second connecting part, which loads the second connecting part in the direction of tilting about a transverse direction perpendicular to the closing direction and the engagement direction. In order to counteract such tilting, the positive-locking section is formed on the first base body, which creates a support for the second base body, in particular in a front region, so that the second base body is supported against tilting, in particular about the transverse direction, and thus a load cannot lead to an unintentional loosening of the connecting parts from one another.

The positive-locking section and the resulting support ensure that the connecting parts are held together securely, reliably and resiliently in the connected position, without the load forces being able to cause the connecting parts to detach from each other.

In the connected position, the second base body buts against the first base body in a first region. For example, a base surface of the second base body can rest against a bottom surface of the first base body, so that in the first region there is a flat contact between the second base body and the first base body. In contrast, in a second region adjoining the first region in the engagement direction, the second base body is not in contact with the first base body, so that a free space is formed between the first base body and the second base body when viewed along the closing direction. A third region adjoins this second region or is spaced from the second region along the engagement direction. This third region of the second base body is supported on the positive-locking section of the first base body.

A support of the second base body on the first base body is thus provided in the manner of a two-point support with a free space created in between (it should be noted that an abutment can also exist in more than two regions). The third region may in particular be formed in a region of the second base body that is forward in the engagement direction, so that the third region can in particular be used to provide support against tilting about a transverse direction perpendicular to the closing direction and the engagement direction. In contrast, the first region can be formed in a rear area of the second base body with respect to the engagement direction.

The free space created between the second region of the second base body and the first base body allows the connecting parts to be easily attached to one another and easily separated from one another. For example, when separating the connecting parts from each other, it may be necessary or advantageous to first move the second connecting part a (small) distance in the opposite direction to the engagement direction with the first connecting part and then to tilt it in the transverse direction to the first connecting part. When tilting, for example, the second and or third region can move into the free space, so that this enables a tilting movement of the second connecting part relative to the first connecting part in a haptically pleasant and comfortable way for a user.

In other words, in the connected position, the second connecting part is fixed to the first connecting part, in particular under load, with restriction of the degrees of freedom. When opening, the connecting parts are moved (for example within a tolerance) against the engagement direction or by slightly tilting relative to each other, so that the second connecting part slides off the positive-locking section and the restriction of the degrees of freedom is thus reduced. This allows the connecting parts to tilt relative to each other. By plunging into the free space, a (stronger) tilting or pivoting movement of the connecting parts relative to each other is thus made possible when opening after an initial movement, which enables a haptically pleasant and convenient separation of the connecting parts from each other for a user.

Due to the fact that the at least one engagement protrusion is formed rigidly and non-deformably (with a load acting as intended) on the first base body of the first connecting part, the engagement protrusion can reliably absorb and dissipate forces when being engaged with the engagement section of the second base body. The at least one engagement protrusion is preferably formed in one piece with the first base body of the first connecting part, wherein the first base body is rigid and non-deformable overall.

In this context, “non-deformable” should be understood to mean an essentially rigid geometry and choice of material of the base body, which ensures that the base body of the first connecting part with the engagement protrusion formed thereon does not deform under the intended load, i.e. the base body is not elastic. For example, the base body of the first connecting part can be made of metal or a hard plastic material.

Similarly, the base body of the second connecting part with the engagement section formed thereon is rigid and non-deformable and is made of metal or a hard plastic material, for example.

Placing of the connecting parts against each other is supported magnetically. For this purpose, the first connecting part comprises a first magnetic device and the second connecting part has a second magnetic device. In the connected position, the first magnetic device and the second magnetic device act together in a magnetically attracting manner and, in particular, also support the placing of the connecting parts against one another. The magnetic devices have a magnetically attracting effect along the closing direction so that the magnetic devices cause a magnetic attracting force along the closing direction and pull the connecting parts towards each other along the closing direction when placing them against one another. The magnetic devices can, for example, each be formed by a permanent magnet. However, it is also possible to configure one of the magnetic devices with a permanent magnet and the other of the magnetic devices with a magnetic armature and thus with a passive magnetic element.

In non-limiting embodiments, when the first connecting part and the second connecting part are tilted relative to each other, for example when the connecting parts are separated from each other, the second base body is configured to move closer to the first base body with the second and/or third region in the closing direction, reducing the free space. For example, the third region of the second base body can move into the free space when tilted in this way, with the third region coming out of contact with the positive-locking section, thus allowing the connecting parts to tilt relative to each other.

In non-limiting embodiments, the first base body comprises a plunge opening into which the third region of the second base body can plunge when the second connecting part is tilted relative to the first connecting part in the closing direction. In particular, the plunge opening can be formed in a front region (with respect to the engagement direction) of the first base body and can, for example, be shaped as a recess on the first base body. The second base body can plunge into the plunge opening, in particular with a front edge section forming the third region, when the connecting parts are tilted relative to each other (during connection or disconnection).

The plunge opening can, for example, be shaped as a recess relative to a bottom surface of the first base body. In this case, the plunge opening adjoins the bottom surface, for example, but is recessed relative to the bottom surface and thus set back along the closing direction. The second base body is in contact with the bottom surface via its first region in the connected position, for example. In particular, the plunge opening can extend below the at least one engagement protrusion and thus provide a space in the region of the at least one engagement protrusion, to which the second region of the second base body is spaced in the connected position to create the free space (with respect to the closing direction) and into which the third region of the second connecting part can plunge when the connecting parts are placed against each other to close the connecting device and also when the connecting parts are separated from each other to open the connecting device.

In general, a clearance between the engagement section of the second connecting part and the at least one engagement protrusion of the first connecting part can facilitate tilting of the connecting parts relative to one another for establishing the connection and also for separating. Tilting is also facilitated by the free space between the second region of the second base body and the first base body in that the third region of the second base body can slide away from the positive-locking section and plunge into the free space after previous slight actuation against the engagement direction and subsequent tilting actuation.

The plunge opening can be configured as a recess or as a through-opening on the first base body.

The positive-locking section can, for example, be formed by a step on which the second base body rests in the connected position. In particular, the positive-locking section may comprise a surface section directed perpendicularly or obliquely to the closing direction, which provides support for the second base body.

In non-limiting embodiments, the positive-locking section can also be formed as an engagement opening, for example in the form of a notch. The positive-locking section creates a support on the first base body perpendicular to the engagement direction, namely along the closing direction, so that the connecting parts cannot easily tilt relative to each other unintentionally in the connected position under load, but are supported against (unintentional) tilting via the positive-locking section.

In non-limiting embodiments, the positive-locking section is spaced apart from the at least one engagement protrusion when viewed along the closing direction. Viewed along the closing direction, the positive-locking section can extend above or below the at least one engagement protrusion.

Additionally or alternatively, the positive-locking section can be spaced apart from the at least one engagement protrusion when viewed along the engagement direction. The positive-locking section is thus located at a different position than the at least one engagement protrusion with respect to the engagement direction. In particular, the positive-locking section can be positioned in front of the at least one engagement protrusion in the engagement direction. The positive-locking section can be arranged radially outside the at least one engagement protrusion, particularly in the case of an advantageous rotatable configuration. In this way, a favorable support can be created via the positive-locking section to prevent the connecting parts from tilting relative to one another, in that the second base body can come into contact with the positive-locking section with a favorable lever arm when load forces act between the connecting parts.

In non-limiting embodiments, the first base body comprises a support section rigidly formed on the first base body, wherein in the connected position the second base body is supported by the support section for load absorption along the engagement direction. The second base body can, for example, form an edge section which comes into supporting contact with the support section when a load is applied in the engagement direction. The edge section can, for example, be formed in a front region of the second base body, wherein the edge section can also extend around the circumference of the second base body. The support section is formed in a front region of the first connecting part with respect to the engagement direction, so that the support section can provide support for the second base body in the engagement direction. When the second connecting part is loaded relative to the first connecting part in the engagement direction, the edge section is thus pressed against the support section and thus supported on the support section. In the connected position, the second base body can thus come into contact with the support section on the first base body of the first connecting part via the edge section, so that load forces can be introduced from the second connecting part into the first connecting part.

It is conceivable here that the edge section is always in contact with the support section in the engagement direction in the connected position. Alternatively, it is also possible that in an unloaded position, the edge section is not in contact with the support section in the engagement direction, but only comes into contact with the support section when the connecting parts are loaded relative to each other.

Forces can be advantageously transferred from the second connecting part to the first connecting part via the support section and the support of the edge section of the second base body on the support section. For example, when the connecting device is configured as a strap fastener, a load direction along which a force acts between the connecting parts when the connecting device is used as intended can be directed along the engagement direction, so that when a load is applied, the engagement section is loaded in the engagement direction with the at least one engagement protrusion. In this case, the edge section of the second base body comes into supporting contact with the support section, so that forces acting in the engagement direction are dissipated via the contact of the edge section with the support section. The at least one engagement protrusion serves in particular to provide support along the closing direction and thus to ensure that the connecting parts are held together, wherein load forces in the engagement direction are primarily absorbed and dissipated via the support section.

In non-limiting embodiments, the support section is curved in an arcuate manner in a cross-sectional plane perpendicular to the closing direction. Accordingly, the edge section can also be curved in an arcuate manner, wherein the arcuate shape of the edge section is advantageously complementary to the arcuate shape of the support section and the edge section can therefore come into flat contact with the support section.

In non-limiting embodiments, the support section is at a distance from the at least one engagement protrusion when viewed along the closing direction. Viewed along the closing direction, the support section can extend above or below the at least one engagement protrusion.

Additionally or alternatively, the support section can be spaced apart from the at least one engagement protrusion when viewed along the engagement direction. With respect to the engagement direction, the support section is thus located at a different position than the at least one engagement protrusion. In particular, the support section can be positioned in front of the at least one engagement protrusion in the engagement direction, so that the support section is arranged radially outside the at least one engagement protrusion. In this way, a favorable support can be created via the support section, in that the second base body can come into contact with the support section with a favorable lever arm when load forces act between the connecting parts.

In non-limiting embodiments, the support section is formed by a surface section that is parallel or inclined to the closing direction. The support section is rigidly formed on the first base body of the first connecting part. Under load, the support section on the first connecting part comes into contact with the second base body of the second connecting part, so that load forces acting in the engagement direction can be absorbed and dissipated in a favorable manner.

In non-limiting embodiments, the second connecting part is twistable about the closing direction relative to the first connecting part in the connected position. On the one hand, this can enable the connecting parts to be attached to each other with angular tolerance. It is also possible to twist the second connecting part relative to the first connecting part when the connecting parts are in the connected position. During a twisting, the engagement section and the at least one engagement protrusion retain their engagement. In addition, a blocking of the engagement by a blocking section (described below) of the first base body also remains in place during the twisting. Twisting the connecting parts relative to each other about the closing direction in the connected position therefore does not result in the connecting parts separating from each other.

The rotatability between the connecting parts in the connected position can enable any rotational movement through any angle. However, it is also conceivable that the movement of the connecting parts is limited to a predetermined angle of rotation, for example by stops or the like. The angle of rotation is preferably greater than 10°, more preferably greater than 20°, particularly preferably greater than 45° or even greater than 90°.

In non-limiting embodiments, the first connecting part comprises a blocking section arranged rigidly on the first base body, which is configured to cooperate with the second connecting part in the connected position in order to block the engagement of the engagement section with the at least one engagement protrusion against the engagement direction. The second connecting part is twistable relative to the first connecting part about the closing direction in the connected position. In the event of a twisting, the engagement of the engagement section with the at least one engagement protrusion and the blocking of the engagement by the blocking section remain in place. The second connecting part can be tilted relative to the first connecting part in order to release the blocking against the engagement direction in order to separate the first connecting part and the second connecting part from one another and to enable the at least one engagement section and the engagement protrusion to be disengaged.

The connecting parts are to be placed against each other along the closing direction, wherein the placing of the connecting parts against each other is magnetically supported by the magnetic devices of the connecting parts. The connecting parts are magnetically pulled towards each other by the magnetic device during attachment and are also magnetically held together in the connected position.

When the connecting parts are placed against each other, the engagement section of the second connecting part engages with the at least one engagement protrusion of the first connecting part in the engagement direction, transversally or obliquely to the closing direction, so that in the connected position there is a form-fit or force-fit connection between the connecting parts and the connecting parts are thus held together in a resilient manner by the engagement of the engagement section with the at least one engagement protrusion.

The engagement between the engagement section of the second connecting part and the at least one engagement protrusion of the first connecting part is secured in the connected position by the blocking section of the first connecting part, which is rigidly formed on the first base body of the first connecting part, in that the blocking section cooperates with an associated section of the second connecting part in a blocking manner opposite to the engagement direction and the engagement section can therefore not be moved opposite to the engagement direction relative to the at least one engagement protrusion, at least not without the blocking being released. Due to the blocking effect of the blocking section, the engagement section is thus blocked in its engagement with the at least one engagement protrusion so that the connecting parts are secured relative to one another in the connected position.

Due to the magnetic effect of the magnetic devices, the connecting parts are held together in the connected position in such a way that the connecting parts are blocked by the blocking section of the first connecting part against the engagement direction. The connecting parts can therefore not be released from each other by a (pure) sliding movement against the engagement direction.

Rather, to release the connecting parts from each other, it is necessary to tilt the connecting parts relative to each other in order to move the second connecting part relative to the first connecting part in a tilting plane spanned by the closing direction and the engagement direction in such a way that the second connecting part can be moved relative to the blocking section against the engagement direction. By tilting the second connecting part relative to the first connecting part, the blocking effect of the blocking section can be released, so that the second connecting part can be moved over the blocking section and thus the engagement section of the second connecting part can be disengaged from the at least one engagement protrusion of the first connecting part.

The blocking effect of the blocking section, which is rigidly arranged on the first base body of the first connecting part, ensures that the second connecting part cannot be moved linearly against the engagement direction, but must be tilted in a tilting plane spanned by the closing direction and the engagement direction in order to separate the connecting parts from each other. The tilting movement can take place around a defined tilting axis. However, the tilting movement can also take place along a curved movement path located in the tilting plane, wherein the second connecting part is tilted relative to the first connecting part as a result of the tilting movement. The tilting movement can be superimposed by a rectilinear movement against the engagement direction and/or against the closing direction.

It should be noted that the connecting parts can be tilted relative to each other to separate the connecting parts. However, the connection between the connecting parts is also not established in a straight closing movement, but by the connecting parts being placed against each other along with a tilting and a wobbling motion and are brought into engagement with each other. When establishing the connection, the second connecting part can also be tilted relative to the first connecting part in order to enable the engagement section of the second connecting part to engage with the at least one engagement protrusion of the first connecting part.

When tilting in order to separate the connecting parts from each other, the second base body is brought out of interaction with the positive-locking section on the first base body by moving its third region slightly against the engagement direction as part of a clearance. A clearance between the second connecting part and the blocking section of the first connecting part, which enables a (slight) displacement movement of the second connecting part against the engagement direction, or a clearance between the second connecting part and the at least one engagement protrusion, which enables a (slight) tilting movement and a subsequent displacement movement of the second connecting part against the engagement direction, can be provided. As a result of the movement within the scope of the clearance, the third region is disengaged from the positive-locking section, for example by the third region sliding off the positive-locking section, which is shaped in the manner of a step, for example. The connecting parts can then be tilted (more) relative to each other so that the connecting parts can be separated from each other.

The depth of the engagement protrusion measured along the engagement direction can be greater than the depth of the contact surface created by the positive-locking section measured along the engagement direction, so that the third region initially slides off the positive-locking section and only then, with further movement against the engagement direction, does the engagement section of the second connecting part disengage from the at least one engagement protrusion on the first connecting part.

In non-limiting embodiments, the second connecting part comprises a blocking element arranged rigidly on the second base body for cooperating with the blocking section of the first connecting part. The blocking element is formed on the second base body and protrudes, for example, along the closing direction from a base surface of the second base body. In the connected position, the blocking element interacts with the blocking section of the first connecting part so that movement of the connecting parts against the engagement direction is blocked. However, by tilting the connecting parts relative to each other, the blocking element can be lifted over the blocking section in order to release the blocking in this way and to move the connecting parts relative to each other while tilting them against the engagement direction, so that the engagement between the engagement section of the second connecting part and the at least one engagement protrusion of the first connecting part can be released and the connecting parts can be separated from each other.

In the connected position, the blocking element is preferably twistable about the closing direction relative to the blocking section, wherein the blocking of the engagement of the engagement section with the at least one engagement protrusion remains in place when it is twisted. For example, the blocking element can have a circular cylindrical shape for this purpose.

In non-limiting embodiments, the first base body comprises a recess which is delimited at least in sections by the blocking section. In the connected position, the blocking element is located in the recess so that the engagement of the engagement section with the at least one engagement protrusion is blocked against the engagement direction. The recess can, for example, be formed as a depression on a bottom surface of the first base body of the first connecting part. The recess is thus molded into the bottom surface. The blocking element is brought into engagement with the recess when the connecting parts are placed against each other so that the second connecting part is held on the at least one engagement protrusion of the first connecting part by the engagement.

In non-limiting embodiments, the recess (in a cross-sectional plane perpendicular to the closing direction) is delimited by at least one boundary wall that implements the blocking section and extends along an arc of a circle. The recess can, for example, have a circular basic shape in which the at least one boundary wall extends in an arcuate manner along an (imaginary) circle centered on an axis.

For example, the recess is limited by two curved boundary walls, which together form the blocking section and, in the connected position, receive the blocking element of the second connecting part between them and thus block movement against the engagement direction of the second connecting part relative to the first connecting part. The one or more boundary walls are arranged at a right angle to the bottom surface, for example, and thus provide support surfaces for the blocking element, so that when a load is applied, the blocking element is supported on the boundary walls and thus blocked relative to the first connecting part.

In non-limiting embodiments, the blocking section comprises a run-up slope. The run-up slope is configured to provide a sliding guide for the blocking element against the engagement direction when the second connecting part is tilted relative to the first connecting part. When the connecting parts tilt relative to each other, for example, a blocking element of the second connecting part can come into contact with the run-up slope, so that the blocking element can run onto the run-up slope and thus be moved over the blocking section. Such a run-up slope can therefore make it easier to separate the connecting parts from each other.

In non-limiting embodiments, the second connecting part can be lifted off the first connecting part for tilting relative to the first connecting part on a side facing away from the at least one engagement protrusion in the opposite direction to the closing direction. In the connected position, the second connecting part engages with the at least one engagement protrusion on the first base body of the first connecting part via the engagement section rigidly formed on the second base body, this engagement being effected in a front region of the second connecting part as seen with respect to the engagement direction. With a rear region with respect to the engagement direction, the second connecting part can be lifted off the first connecting part in the connected position against the closing direction in order to tilt the second connecting part relative to the first connecting part in this way and thereby release the blocking effect of the blocking section of the first connecting part, so that the second connecting part can be moved relative to the blocking section of the first connecting part and the engagement section can be disengaged from the at least one engagement protrusion against the engagement direction.

In order to facilitate handling for a user, the second connecting part can, for example, comprise an actuating section on which a user can act to tilt the second connecting part relative to the first connecting part. The actuating section can, for example, be formed by a tab in the rear region of the second connecting part, which a user can pull on in order to lift the second connecting part with the rear region against the closing direction off the first connecting part. However, the actuating section can also be formed, for example, by a recessed grip or another grip section on which a user can grip in order to tilt the second connecting part relative to the first connecting part in this way.

In non-limiting embodiments, the at least one engagement protrusion is curved in an arcuate manner around the closing direction. If a (single) engagement protrusion is provided, it thus extends in an arcuate manner around the closing direction. If several engagement protrusions are provided, each engagement protrusion can, for example, extend in an arcuate manner around the closing direction. Additionally or alternatively, the engagement protrusions may be lined up along a circumferential direction pointing around the closing direction, so that the engagement protrusions are lined up along an arcuate line and jointly establish engagement with the engagement section of the second connecting part when the connecting parts are in the connected position.

The at least one engagement protrusion extends about the closing direction by an angle of less than 180°, preferably less than 150°, to allow the engagement section to be brought into engagement with the at least one engagement protrusion in the engagement direction.

The at least one engagement protrusion preferably forms an undercut with respect to the closing direction. The at least one engagement protrusion is thus undercut with respect to the closing direction, in that the at least one engagement protrusion protrudes transversely to the closing direction from an associated section of the first connecting part.

The undercut can be formed by a surface extending perpendicular to the closing direction or obliquely (at an acute or obtuse angle).

Likewise, the engagement section of the second connecting part preferably forms an undercut with respect to the closing direction. The engagement section is thus undercut with respect to the closing direction in that the engagement section protrudes transversely to the closing direction from an associated section of the second connecting part.

The undercut can again be formed by a surface extending perpendicularly or obliquely (at an acute or obtuse angle) to the closing direction.

In non-limiting embodiments, the engagement section extends circumferentially around the closing direction. The engagement section can, for example, be arranged on a pin element and protrude from the pin element transversely to the closing direction.

For example, the engagement section is rotationally symmetrical with respect to the closing direction. This makes it possible to bring the engagement section into engagement with the at least one engagement protrusion on the first connecting part in any rotational position of the second connecting part relative to the first connecting part, so that there is engagement between the engagement section and the at least one engagement protrusion in any rotational position of the second connecting part relative to the first connecting part and the connecting parts are thus twistable relative to one another without the engagement of the engagement section with the at least one engagement protrusion being released.

In non-limiting embodiments, the second base body of the second connecting part comprises a base section.

In non-limiting embodiments, the base section can form the engagement section so that the engagement section is shaped for engagement with the at least one engagement protrusion of the first connecting part on the base section, for example on a circumferential edge section of the base section.

In non-limiting embodiments, the engagement section is spaced apart from the base section along the closing direction. The engagement section is thus spatially separated from the base section, for example in that the base section extends along a first plane and the engagement section extends along a second plane that is spaced apart from the first plane along the closing direction.

If the engagement section is physically spaced from the base section, the engagement section is formed, for example, on a pin element which protrudes from the base section along the closing direction. In this case, the engagement section protrudes along the engagement direction from the pin section and thus forms an undercut, so that the engagement section can be brought into engagement with the at least one engagement protrusion of the first connecting part to produce a form-fit or force-fit connection.

The engagement section can, for example, be formed circumferentially on the pin element. In this way, a mushroom-shaped engagement element can be provided which can be brought into engagement with the at least one engagement protrusion of the first connecting part in any rotational position in order to connect the connecting parts to one another and hold them together in the connected position.

If the engagement section is spatially spaced from the base section, the base section can extend further radially to the closing direction than the engagement section and thus protrude radially beyond the engagement section. The engagement section is thus in a radially inner position, while an outer edge of the base section is arranged radially outside the engagement section. In this way, a favorable support of the second connecting part on the first connecting part can be provided via the base section when the connecting parts are in their connected position.

In non-limiting embodiments, for example, the base section is shaped like a disk. The base section can, for example, have a circular cylindrical basic shape with a circular cross-section.

For example, a fastening section can be formed on the base section, via which a strap is connected to the second connecting part.

In non-limiting embodiments, the base section comprises a base surface and the first base body comprises a bottom surface. The base surface and the bottom surface each extend perpendicular to the closing direction. In the connected position, the base surface on the base section of the second connecting part and the bottom surface on the first base body of the first connecting part face each other.

For example, in the connected position, there can be a contact between the base surface and the bottom surface. When the connecting parts are rotated or twisted relative to each other about the closing direction, the base surface and the bottom surface are thus moved against each other in a sliding manner.

However, this is not mandatory. It is also conceivable that there is a gap (and therefore no contact) between the base surface and the bottom surface in the connected position.

In non-limiting embodiments, the base section can be tilted relative to the first connecting part about a tilting axis perpendicular to the closing direction and the engagement direction in order to tilt the connecting parts relative to one another. The tilting of the connecting parts to separate the connecting parts from each other is thus achieved by tilting the base section about a tilting axis relative to the first base body of the first connecting part. The tilting axis can be defined by a contact line between the base section and the first base body. However, it is also conceivable that the tilting axis corresponds to an imaginary line that extends through the base section or outside the base section and corresponds to such a line about which the base section is pivoted relative to one another when the connecting parts are tilted.

In non-limiting embodiments, the at least one engagement protrusion comprises, for example, a sliding slope which serves as a guide slope in order to guide the connecting parts when they are placed against one another, in such a way that the connecting parts can be brought into engagement with one another in an easy, preferably largely automatic manner. Preferably, the sliding slope is configured to guide the second connecting part along the closing direction on the at least one engagement protrusion when it is placed against the first connecting part, such that the second connecting part is offset against the engagement direction with the first connecting part and is thereby moved past the at least one engagement protrusion. After moving past, the second connecting part can then be brought into engagement with the at least one engagement protrusion of the first connecting part in the engagement direction. By sliding on the at least one engagement protrusion, the second connecting part is thus guided relative to the first connecting part in such a way that the second connecting part is moved past the at least one engagement protrusion. Once the second connecting part has passed the at least one engagement protrusion with its engagement section, the engagement section can be brought into engagement with the at least one engagement protrusion on the first connecting part in the engagement direction.

In non-limiting embodiments, a strap fastener comprises a connecting device according to the type described above. In particular the second connecting part can be connected to a strap, wherein the strap is fixed and non-adjustable, but may also be arranged on the second connecting part in an adjustable manner.

The first connecting part can also be connected to a strap but can also be fixedly arranged on an associated assembly, for example a textile object or another object.

In non-limiting embodiments, the first connecting part comprises, when using the connecting device with a strap fastener, two engagement protrusions which are spaced apart from one another transversely to the closing direction and transversely to the engagement direction in such a way that the strap can be guided through between the engagement protrusions in the connected position of the first connecting part and the second connecting part. The strap is thus received between the engagement protrusions so that the second connecting part is supported on both sides of the strap relative to the first connecting part via the engagement protrusions.

In another application, an object fastening device may comprise a connecting device of the type described above for fastening an object to an assembly. In this case the object may be arranged on one of the connecting parts, for example integrated into the connecting part. In contrast, the other one of the connecting parts is arranged in the assembly, so that the object can be secured to the assembly by connecting the connecting parts.

The possible uses listed below are intended to illustrate the wide range of applications of the connecting device, but are not intended to be limiting and, in particular, not exhaustive. The connecting device can be used for:
helmet fastener
horse halter,
removable (chest) pouch,
bags, backpacks
for roll tops, for closing with (elastic) strap
jacket fasteners (e.g. on sleeves, lapels, button placket, or tying up shirt sleeves)
roller blinds in motorhomes, caravan privacy screens
conceals
awnings, tarpaulins, camping tents, tent guy ropes
fastening or closing panniers or saddlebags (bike, motorcycle)
luggage and load securing, or securing bicycles/prams in and on public transport vehicles
sorting & securing system for craftsmen in the vehicle
strap fasteners, restraint systems and fastening devices for carrying equipment
chest straps, hip straps, shoulder straps
detachable handles or carrying straps on bags
folding sunshade, e.g. on baby carriages
movable and detachable or openable connection of backpack carrying straps
suspension for clothes hangers
furniture, for example for attaching seating elements
sleeping bags, sleeping mats, yoga mats (for rolling up and fastening)
towel rails
key holder
belts
tool belts with hook-on tool
detachable carrying straps, e.g. on tools and garden equipment, handles for bags and electrical appliances
gloves, shoes, golf bags (for closing or fastening together)
a mosquito repellent in the baby carriage or tent
a luggage strap, for example to secure items in the bike basket
for components and accessories on the bike (speedometer, lights, computer, electronic devices, etc.).

### BRIEF DESCRIPTION OF THE DRAWINGS

The idea underlying the disclosure will be explained in more detail below with reference to the embodiments shown in the figures:

FIG. 1 shows a view of a non-limiting embodiment of a connecting device according to the principles of the present disclosure;

FIG. 2A shows an exploded view of the connecting device;

FIG. 2B shows the exploded view in a different perspective;

FIG. 3A shows a separate view of a first connecting part of the connecting device;

FIG. 3B shows another view of the first connecting part;

FIG. 4A shows a top view of the first connecting part;

FIG. 4B shows a view of the first connecting part from below;

FIG. 4C shows a sectional view along line G-G as shown in FIG. 4B;

FIG. 5A shows a view of a second connecting part with a strap arranged on it;

FIG. 5B shows another view of the second connecting part with the strap arranged on it;

FIG. 6A shows a view of the second connecting part from below;

FIG. 6B shows a top view of the second connecting part;

FIG. 6C shows a sectional view along line I-I as shown in FIG. 6B;

FIG. 7A shows a view of the connecting device when connecting the connecting parts;

FIG. 7B shows a sectional view along line B-B as shown in FIG. 7A;

FIG. 8A shows a view of the connecting device during further closing;

FIG. 8B shows a sectional view along line C-C as shown in FIG. 8A;

FIG. 9A shows a view of the connecting device during further closing;

FIG. 9B shows a sectional view along line D-D as shown in FIG. 9A;

FIG. 10A shows a view of the connecting device during further closing;

FIG. 10B shows a sectional view along line E-E as shown in FIG. 10A;

FIG. 10C shows a sectional view along line L-L as shown in FIG. 10A;

FIG. 11A shows a view of the connecting device in a connected position of the connecting parts;

FIG. 11B shows a sectional view along line J-J as shown in FIG. 11A;

FIG. 11C shows a sectional view along line K-K as shown in FIG. 11B;

FIG. 11D shows a sectional view along line F-F as shown in FIG. 11B;

FIG. 11E shows the sectional view according to FIG. 11B, in an enlarged view;

FIG. 12A shows a top view of the connecting device in a position of the second connecting part twisted relative to the first connecting part;

FIG. 12B shows a side view of the arrangement shown in FIG. 12A;

FIG. 12C shows a sectional view along the line N-N according to FIG. 12A;

FIG. 12D shows a side view of the connecting device obliquely from behind;

FIG. 12E shows a top view of the connecting device;

FIG. 12F shows a sectional view along line M-M as shown in FIG. 12E;

FIG. 13A shows a view of a second connecting part, according to another non-limiting embodiment of a connecting device according to the principles of the present disclosure;

FIG. 13B shows another perspective view of the second connecting part;

FIG. 14A shows a view of the second connecting part from below;

FIG. 14B shows a top view of the second connecting part;

FIG. 14C shows a sectional view along line E-E as shown in FIG. 14B;

FIG. 15A shows a view of a first connecting part against which the second connecting part according to FIGS. 13A, 13B and 14A-14C can be placed;

FIG. 15B shows another view of the first connecting part;

FIG. 16A shows a view of the first connecting part from below;

FIG. 16B shows a top view of the first connecting part;

FIG. 16C shows a sectional view along line F-F as shown in FIG. 16B;

FIG. 17A shows a view of the connecting device during closing;

FIG. 17B shows a sectional view along line A-A as shown in FIG. 17A;

FIG. 18A shows a view of the connecting device during further closing;

FIG. 18B shows a sectional view along line B-B as shown in FIG. 18A;

FIG. 19A shows a view of the connecting device during further closing;

FIG. 19B shows a sectional view along line C-C as shown in FIG. 19A;

FIG. 20A shows a view of the connecting device in a connected position of the connecting parts;

FIG. 20B shows a sectional view along line D-D as shown in FIG. 20A;

FIG. 20C shows a sectional view along line G-G as shown in FIG. 20B;

FIG. 20D shows a sectional view along line H-H as shown in FIG. 20B;

FIG. 21 shows a view of another non-limiting embodiment of a connecting device according to the principles of the present disclosure;

FIG. 22A shows a perspective exploded view of the connecting device;

FIG. 22B shows another exploded view of the connecting device;

FIG. 23A shows a separate view of a first connecting part of the connecting device;

FIG. 23B shows another view of the first connecting part;

FIG. 24A shows a top view of the first connecting part;

FIG. 24B shows a view of the first connecting part from below;

FIG. 24C shows a sectional view along line F-F as shown in FIG. 24B;

FIG. 25A shows a view of a second connecting part of the connecting device;

FIG. 25B shows another view of the second connecting part;

FIG. 26A shows a view of the second connecting part from below;

FIG. 26B shows a top view of the second connecting part;

FIG. 26C shows a sectional view along line G-G as shown in FIG. 26B;

FIG. 27A shows a view of the connecting device during closing;

FIG. 27B shows a sectional view of the connecting device along line A-A as shown in FIG. 27A;

FIG. 28A shows a view of the connecting device during further closing;

FIG. 28B shows a sectional view along line B-B as shown in FIG. 28A;

FIG. 29A shows a view of the connecting device during further closing;

FIG. 29B shows a sectional view along line C-C as shown in FIG. 29A;

FIG. 30A shows a view of the connecting device in a connected position of the connecting parts;

FIG. 30B shows a sectional view along the line O—O as shown in FIG. 30A;

FIG. 30C shows a sectional view along line A-A as shown in FIG. 30B;

FIG. 30D shows sectional view along line Q-Q as shown in FIG. 30B;

FIG. 31A shows an exploded view of another non-limiting embodiment of a connecting device according to the principles of the present disclosure;

FIG. 31B shows a sectional view of the connecting device during closing, corresponding to the sectional view shown in FIG. 29B;

FIG. 31C shows a sectional view of the connecting device in a connected position of the connecting parts, corresponding to the sectional view according to FIG. 30B; and

FIGS. 32 to 58 show views of different possible uses of the connecting device.

### DETAILED DESCRIPTION

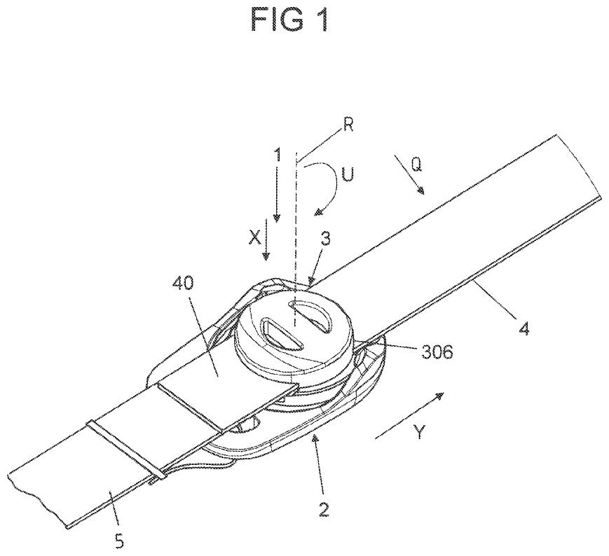

In an exemplary embodiment shown in FIGS. 1 to 12A-12F, a connecting device 1 comprises a first connecting part 2 (so-called female part) and a second connecting part 3 (so-called male part) to be placed against the first connecting part 2.

The connecting parts 2, 3 can generally be placed against one another along a closing direction X, wherein the connecting parts 2, 3 each comprise a magnetic device 21, 31 in the form of a permanent magnet (or alternatively in the form of a permanent magnet on the one hand and a magnetic armature on the other) which cooperate in a magnetically attracting manner and pull the connecting parts 2, 3 towards one another along the closing direction X.

It should be noted that the connecting parts 2, 3 can also be positioned in a direction that deviates from the closing direction X, for example obliquely to the closing direction X. The magnetic devices 21, 31 cooperate in a magnetically attracting manner along the closing direction X and pull the connecting parts 2, 3 towards one another along the closing direction X.

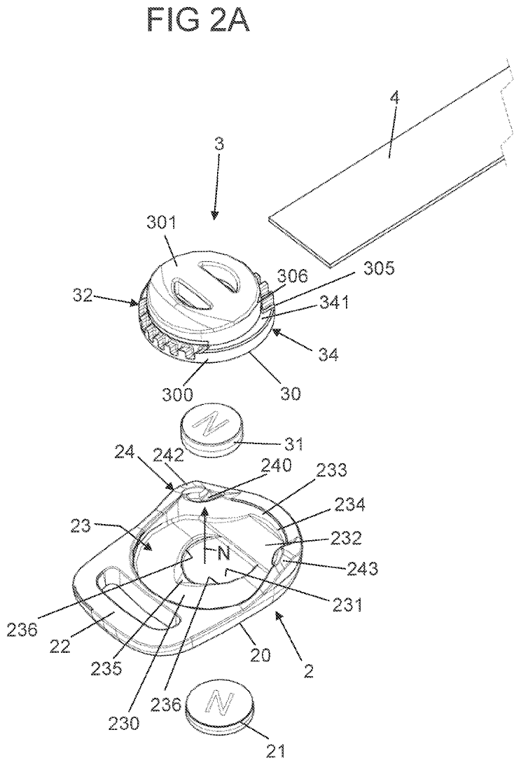

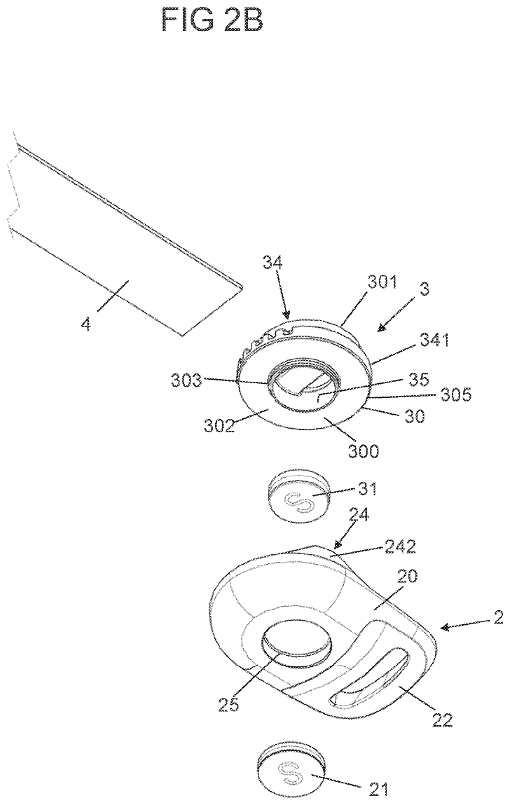

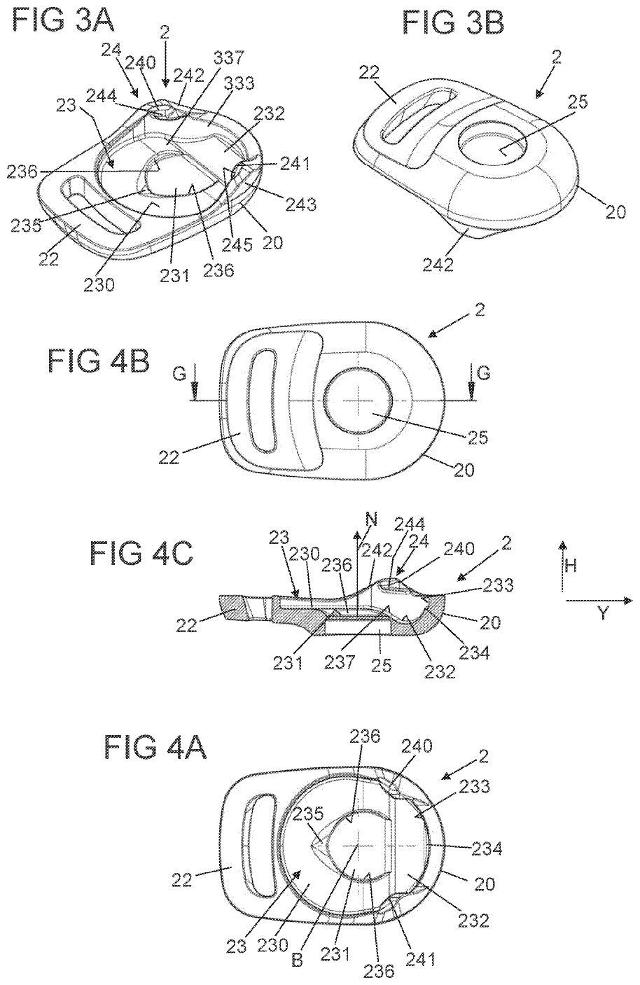

As can be seen from the exploded views according to FIGS. 2A and 2B and the separate views according to FIGS. 3A, 3B and 4A-4C, the first connecting part 2 comprises a base body 20 which forms a receiving opening 23 for receiving the second connecting part 3. A strap receptacle 22 in the form of a web and an opening adjoining it, to which a strap 5 can be attached or is attached, is arranged on the base body 20. On a side facing away from the receiving opening 23, the base body 20 forms a fastening opening 25 for receiving the magnetic device 21.

The receiving opening 23 is formed as a recess on the base body 20. Within the receiving opening 23, a bottom surface 230 is formed in the form of a flat surface extending perpendicular to the closing direction X, with which the second connecting part 3 can be brought into flat contact when inserted into the receiving opening 23 to establish a connection between the connecting parts 2, 3.

A recess 231 in the form of a depression is formed in the bottom surface 230, into which—as will be described below-a blocking element 303 engages on a base section 300 of the second connecting part 3 when the connecting parts 2, 3 are in the connected position.

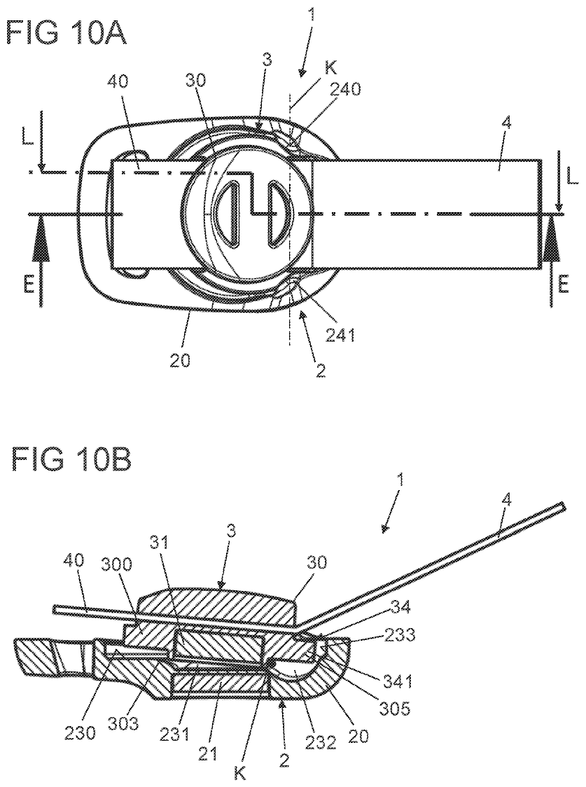

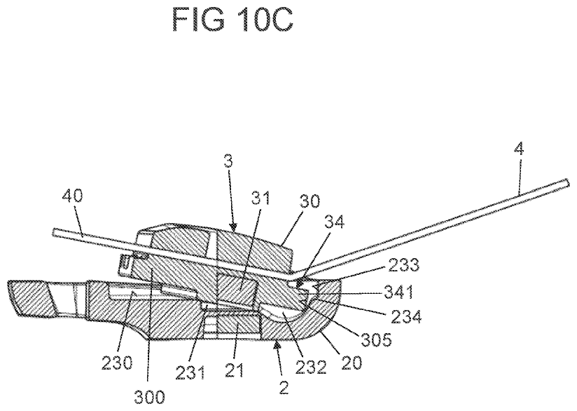

The receiving opening 23 is delimited at a front end by a support section 233, which serves as a support and load-bearing means for the second connecting part 3 in the connected position. An plunge opening 232 is formed between the support section 233 and the bottom surface 230, which serves to facilitate the establishment of the connection as well as the separation of the connecting parts 2, 3 in that an edge section 305 of the base section 300 of the second connecting part 3 can be plunged in the plunge opening 232 when the connection is established and also when the connection is separated, as can be seen, for example, in FIG. 10B and will be described below.

The plunge opening 232 is formed as a recess relative to the bottom surface 230 and adjoins the bottom surface 230 in such a way that the plunge opening 232 is located between the support section 233 and the bottom surface 230. At the transition between the plunge opening 232 and the bottom surface 230, a inclined transition surface 237 is formed, which serves as a guide for the second connecting part 3 for establishing the connection in the same way as when disconnecting the connection.

On the rigidly formed base body 20, engagement protrusions 240, 241 are arranged on two lateral, raised sections 242, 243 rigidly formed with the base body 20, which-viewed along a height direction H pointing along the closing direction X—are located above the bottom surface 230 and serve to establish a positive or force-locking connection between the connecting parts 2, 3 in a connected position. The engagement protrusions 240, 241 are spaced apart from one another along a transverse direction Q. The engagement protrusions 240, 241 together form an engagement device 24, which enables positive or force-forming engagement with the second connecting part 3. As will be explained below, the base section 300 of the second connecting part 3 is received in a connected position with an engagement section 341 formed thereon between the engagement protrusions 240, 241 and the bottom surface 230 and is also supported at a front edge 305 on the support section 233, so that the connecting parts 2, 3 are held together securely and reliably thereabove.

Sliding slopes 244, 245 are formed on the engagement protrusions 240, 241, which are inclined obliquely to the height direction H and cause the second connecting part 3 to slide against an engagement direction Y when the connecting parts 2, 3 are placed against each other along the closing direction X.

The recess 231 is laterally bounded by arcuate boundary walls 236, which together implement a blocking section of the first connecting part 2 and are aligned perpendicular to a bottom of the recess 231 and also to the bottom surface 230. The boundary walls 236 extend in a circular arc around a central axis B of the recess 231, which is directed along a normal direction N of the bottom surface 230.

A run-up slope 235 is formed between the boundary walls 236, which is arranged at the rear of the support section 233 at the recess 231 and provides a sliding surface in order to facilitate the sliding of the blocking element 303 into the recess 231 and also the release of the blocking element 303 from the recess 231.

The bottom surface 230 extends flat along a plane perpendicular to the normal direction N.

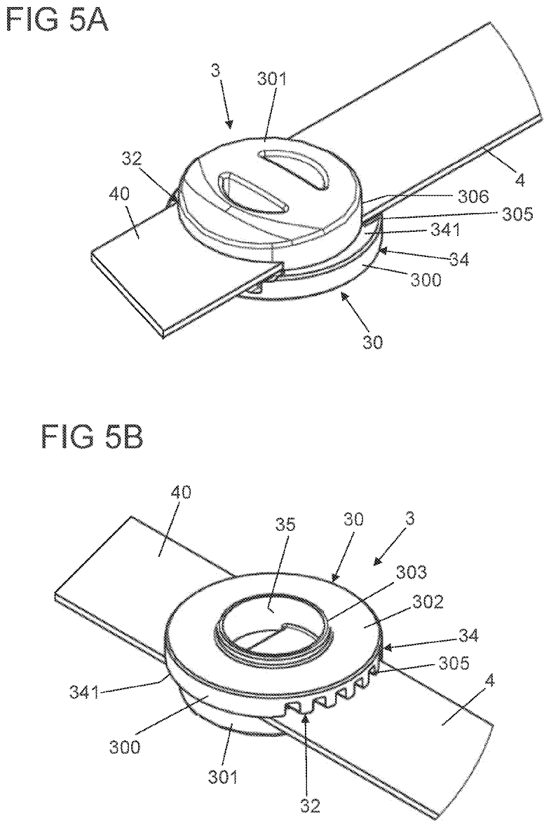

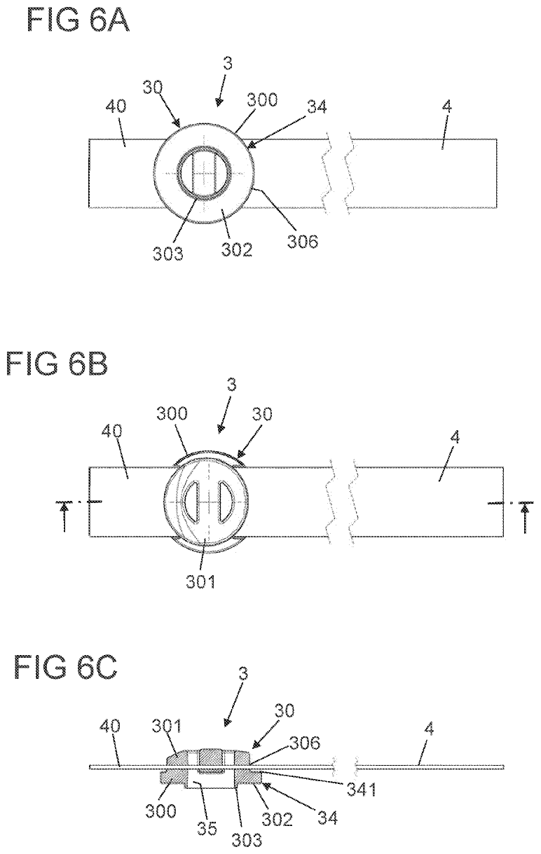

The second connecting part 3 is fixedly connected to a strap 4 as shown in the exploded views according to FIGS. 2A, 2B and the separate views according to FIGS. 5A, 5B and 6A-6C. The second connecting part 3 comprises a base body 30, on which the strap 4 is fixedly and non-adjustably arranged, in that the strap 4 is located in a strap receptacle 32 formed between a base section 300 and a fastening section 301 and is thereby fixedly arranged on the base body 30.

The base body 30 can, for example, be formed in one piece and integrally with the base section 300 and the fastening section 301 by plastic injection molding, with the strap 4 being overmolded in sections and thus firmly and non-adjustably connected to the base body 30.

The base section 300 has a circular cylindrical basic shape and forms a base surface 302 on a side facing the first connecting part 2 (when the connection is made), which base surface is flat and comes into contact with the bottom surface 230 in the receiving opening 23 when the second connecting part 3 is attached to the first connecting part 2.

A blocking element 303, which is concentric with the circular cylindrical base section 300 and circular in cross-section, protrudes from the base surface 302 and serves to engage in the recess 231 on the bottom surface 230 of the base body 20 of the first connecting part 2.

A fastening opening 35 is formed within the blocking element 303, which serves to receive the magnetic device 31, for example in the form of a permanent magnet of the second connecting part 3, and within which the magnetic device 31 is fastened.

The base section 300 forms an engagement device 34 of the second connecting part 3 with an engagement section 341, which serves to cooperate with the engagement protrusions 240, 241 of the engagement device 24 of the first connecting part 2 and, when the connection is made, plunges under the engagement protrusions 240, 241 so that a positive or force-locking connection is made between the connecting parts 2, 3.

In the embodiment shown, the engagement section 341 is formed by a circumferential edge of the base section 300 which protrudes radially with respect to the fastening section 301 and thus forms an undercut via which the engagement section 341 can be brought into engagement with the engagement protrusions 240, 241 of the first connecting part 2 which also form undercuts in order to connect the connecting parts 2, 3 to one another.

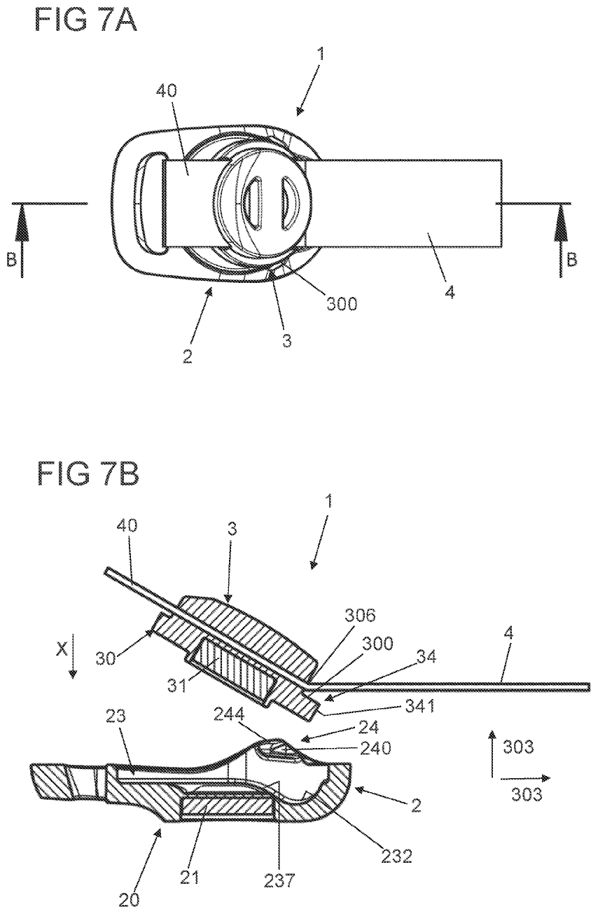

FIGS. 7A, 7B to 11A-11D show a connection process of the connecting device 1.

The connecting parts 2, 3 are generally attached to each other along the closing direction X, along which the magnetic devices 21, 31 cooperate in a magnetically attracting manner and thus pull the connecting parts 2, 3 towards one another in a magnetically attracting manner. The connecting parts 2, 3 can be brought closer together manually, whereby the magnetic attraction force automatically draws the connecting parts 2, 3 into engagement from a certain proximity and thus establishes the connection of the connecting device 1. An imprecise placing of the connecting parts 2, 3 against each other is therefore sufficient, wherein the connection is then established largely automatically.

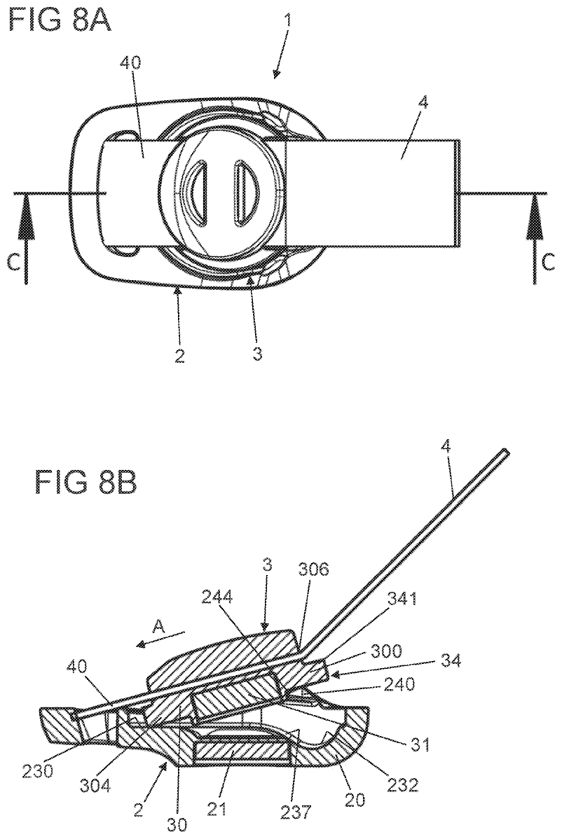

If the connecting parts 2, 3 are brought closer together, as can be seen from FIGS. 7A and 7B, the base section 300 of the base body 30 of the second connecting part 3 comes into contact with the engagement protrusions 240, 241 along the closing direction X from above, as can be seen from FIGS. 8A, 8B. Due to the inclined sliding slopes 244, 245 formed on the engagement protrusions 240, 241, the base section 300 slides along a sliding direction A on the engagement protrusions 240, 241, wherein the base section 300 can come into contact with the bottom surface 230 in the receiving opening 23 of the first connecting part 2 with a rear edge 304, as shown in FIG. 8B, and thereby slides along the bottom surface 230 in a guided manner without the blocking element becoming prematurely caught.

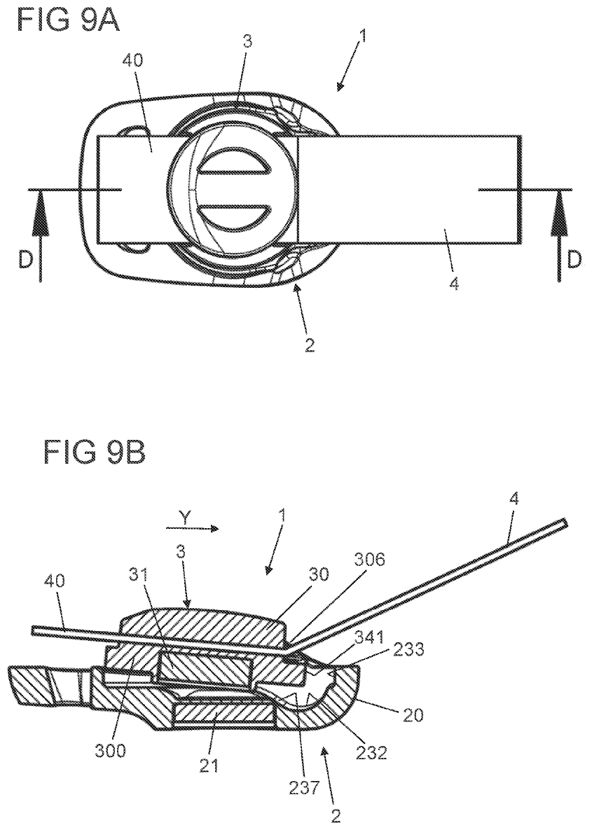

Once the base section 300 has slid off the engagement protrusions 240, 241 and the base section 300 has thus passed the engagement protrusions 240, 241 in the closing direction X, the engagement section 341 formed on the circumferential edge of the base section 300 now slides into engagement with the engagement protrusions 240, 241 in an engagement direction Y, assisted by the magnetic attraction of the magnetic devices 21, 31, as can be seen from FIGS. 9A, 9B and 10A, 10B. This movement along (approximately) the engagement direction Y takes place in a magnetically assisted manner, wherein an additional load force (introduced via the strap 4) can support the engagement.

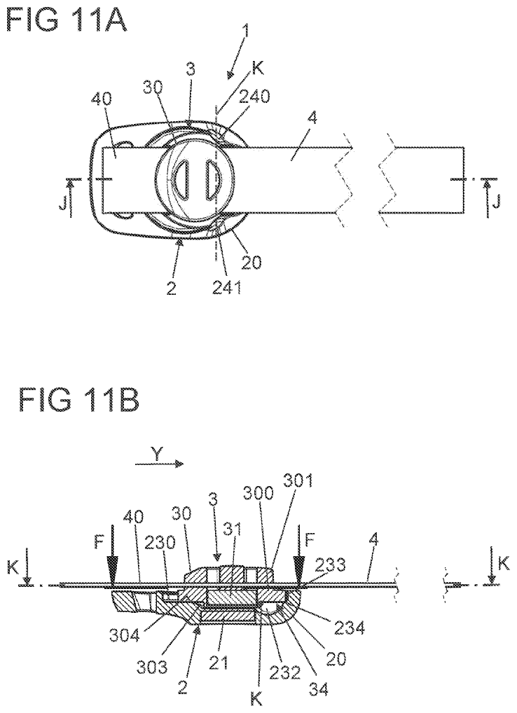

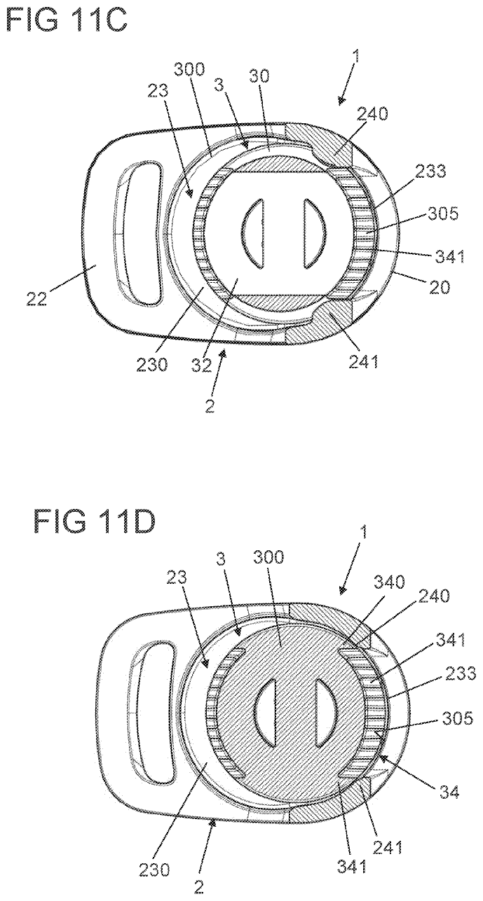

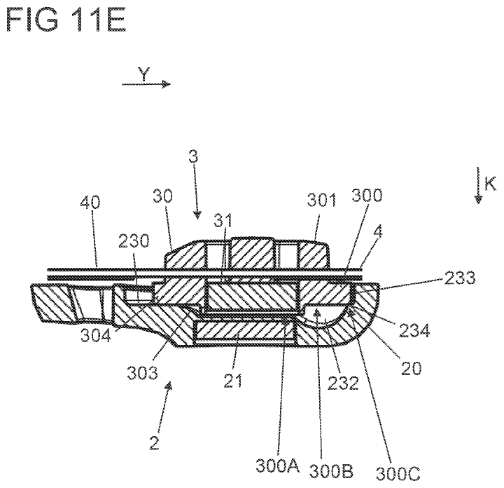

When the engagement section 341 moves in the engagement direction Y into engagement with the engagement protrusions 240, 241, the blocking element 303 slides into the recess 231 in the receiving opening 23 of the first connecting part 2, as can be seen in the transition from FIGS. 10A, 10B to FIGS. 11A-11D.

In the connected position shown in FIGS. 11A-11E, the blocking element 303 is located in the recess 231 and the base section 300 is located with the base surface 302 formed thereon flat against the bottom surface 230 within the receiving opening 23 of the first connecting part 2, as can be seen in particular from the sectional view according to FIG. 11B.

In the connected position, the base section 300 faces the support section 233 with a (front) edge section 305 and rests against the support section 233 in a supporting manner. If a force is introduced into the second connecting part 3 via the strap 4, this force is absorbed and dissipated by the supporting contact of the base section 300 on the support section 233.

As can be seen from FIGS. 11C and 11D, the support section 233 is curved in an arcuate manner around the closing direction X, corresponding to the curvature of the circular cylindrical base section 300, so that there is contact along an arcuate support line or surface between the edge section 305 on the base section 300 and the support section 233.

The support section 233 is arranged with a central section, viewed along the transverse direction Q, between the engagement protrusions 240, 241 and is spaced at the central section along the engagement direction Y from the engagement protrusions 240, 241. The support section 233 extends in the cross-sectional plane according to FIG. 11D in an arcuate manner to below the engagement protrusions 240, 241 and beyond, so that a planar support for the base section 300 is provided centrally between the engagement protrusions 240, 241 and also directly in the region of the engagement protrusions 240, 241.

In the connected position, the strap 4 on the connecting part 3 is arranged approximately at the height of the engagement protrusions 240, 241 on the connecting part 2 or below the engagement protrusions 240, 241. This has the effect that strap forces introduced via the strap 4 cannot tilt the connecting part 3 in the receiving opening 23 or can only generate a low tilting moment, with the engagement protrusions 240, 241 securing the position of the connecting part 3 on the connecting part 2, in particular along the height direction H.

In the connected position and with load effects between the connecting parts 2, 3, the strap 4 is located between the raised sections 242, 243 and is thus arranged between the engagement protrusions 240, 241, so that the engagement protrusions 240, 241 create a support symmetrical to the strap 4 when force is applied via the strap 4.

In the connected position, the magnetic devices 21, 31 act together in a magnetically attracting manner and thus hold the connecting parts 2, 3 in the connected position.

Due to the engagement of the blocking element 303 in the recess 231, tangential displacement of the connecting parts 2, 3 against the engagement direction Y relative to one another is also blocked. In the connected position, the blocking element 303 is located in the recess 231 in such a way that the blocking element 303 is received between the boundary walls 236 implementing the blocking section and is in blocking contact with the arcuate boundary walls 236, so that the blocking element 303 cannot be moved relative to the boundary walls 236 against the engagement direction Y.

Due to the rotationally symmetrical shape of the blocking element 303 and the circular cylindrical shape of the base section 300, the connecting part 3 can be rotated in the connected position along a circumferential direction U (see FIG. 1) within the receiving opening 23 of the connecting part 2 by any angle about an axis of rotation R, while maintaining the connecting engagement between the connecting parts 2, 3 and also the blocking of the blocking element 303 in the recess 231.

This twistability also allows the connecting parts 2, 3 to be placed against each other in any rotational position, whereby when a load is applied via the strap 4, the connecting parts 2, 3 are aligned with each other in such a way that the strap 4 comes to rest between the engagement protrusions 240, 241 and the connecting part 3 is thus supported symmetrically on the connecting part 2. Due to the twistability, the connecting parts 2, 3 can be placed against each other with positional tolerance, which makes it easy and convenient to make the connection.

As can be seen from FIGS. 10A-10C, when the base section 300 with a front edge section 305 slides under the engagement protrusions 240, 241, it plunges into the plunge opening 232, which is recessed with respect to both the bottom surface 230 and the recess 231. By plunging the edge section 305 into the plunge opening 232, the blocking element 303 can slide into the recess 231 and the engagement of the engagement section 341 formed on the base section 300 with the engagement protrusions 240, 241 can be established. In addition, the angular range of an opening force applied to the actuating section 40 (tab) can thus be increased and jamming of the edge section 305 during opening can be prevented.

In the connected position, the front edge section 305 of the base section 300 then rests on a form-fitting section in the form of a step 234 formed between the plunge opening 232 and the support section 233 and located at the level of the bottom surface 230, as can be seen in particular from FIG. 11B. By placing the base section 230 against the step 234, the connecting part 3 is additionally supported against tilting relative to the connecting part 2.

Alternatively, the positive-locking section may also be formed, for example, by a notch or the like on the support section 233, in which the base section 300 engages with the edge section 305 and is thereby supported on the support section 233 against tilting associated with a downward movement of the edge section 305 on the support section 233 in the closing direction X.

In the connected position according to FIGS. 11A to 11E, the positive-locking section in the form of the step 234 counteracts, in particular, tilting when a load is applied to the strap 4. Thus, in the connected position, the second connecting part 3 with its base body 30 rests with a first region 300A, formed by the rear section (with respect to the engagement direction Y) and the blocking element 303, on the bottom surface 230 of the base body 20 of the first connecting part 2 and is located in the recess 231 (see FIG. 11E). In contrast, in a second region 300B adjoining in the engagement direction Y, formed by the section above the plunge opening 232, the second base body 30 of the second connecting part 3 does not rest against the first base body 20 of the first connecting part 2. With a third region 300C adjoining the second region 300B in the engagement direction Y, formed by the front edge section 305 of the base section 300, the second base body 30 rests on the step 234, so that in the connected position a support in the manner of a two-point support is created, with a free space created between them in the region of the plunge opening 232.

In the loaded position, the base section 300 is loaded with the front edge section 305 against the support section 233 and thus held in self-reinforcing contact with the step 234.

If the connecting parts 2, 3 are to be separated from each other, the movement sequence according to FIGS. 7A, 7B to 11A-11D is essentially reversed. In particular, to separate the connecting parts 2, 3, a user can act on an actuating section in the form of a tab 40 (formed by a protruding section of the strap 4) on a rear side of the connecting part 3 facing away from the engagement protrusions 240, 241, thereby lifting the connecting part 3 at its rear end from the bottom surface 230 and thus tilting the connecting part 3 from the connected position according to FIGS. 11A-11D in such a way that the base section 300 with the front edge section 305 slides off the step 234 and the blocking element 303 is lifted out of the recess 231, as can be seen in FIGS. 10A and 10B. In this way, the blocking is released against the engagement direction Y between the connecting parts 2, 3, so that the connecting part 3 can be pulled out of engagement from the connecting part 2 against the engagement direction Y and the connecting parts 2, 3 can thus be released from each other.

The tilting takes place in a tilting plane that is perpendicular to the bottom surface 230, i.e. is spanned by the closing direction X and the engagement direction Y. The tilting takes place approximately about a tilting axis K (see FIGS. 10A and 10B) in such a way that the connecting part 3 performs a pivoting movement in the tilting plane perpendicular to the tilting axis K and thus the blocking element 303 is lifted out of the recess 231, so that the connecting parts 2, 3 can be moved relative to each other against the engagement direction Y and thus separated from each other.

If, in particular when the connecting device 1 is unloaded, the connection of the connecting parts 2, 3 is to be released, the connecting parts 2, 3 are tilted relative to each other and in particular also moved relative each other against the engagement direction Y, so that the front edge section 305 (forming the third region 300C) of the base section 300 slides off the step 234 and plunges into the region of the plunge opening 232, as can be seen in FIG. 10B. The positive-locking section created by the step 234 thus does not (or no longer) counteract tilting, so that the connecting parts 2, 3 can be conveniently and easily separated from one another via the actuating section 40 in the event of tilting.

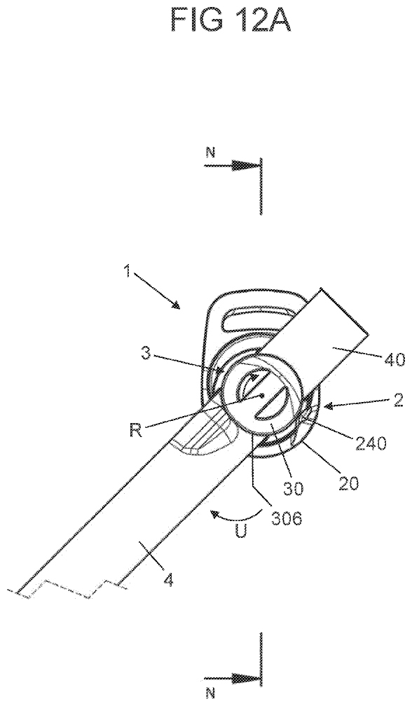

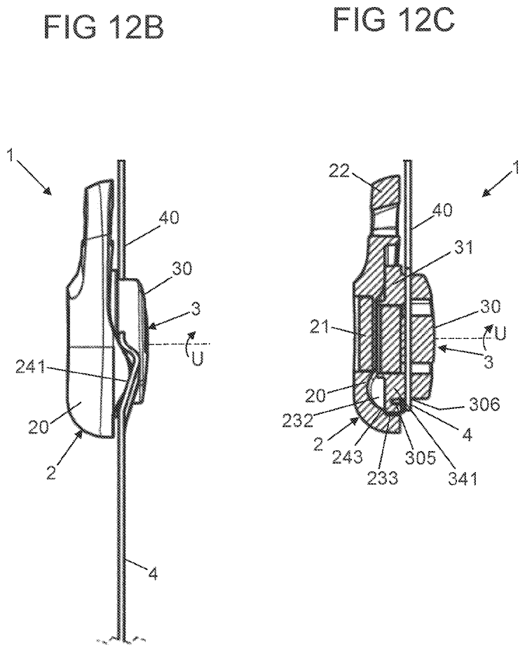

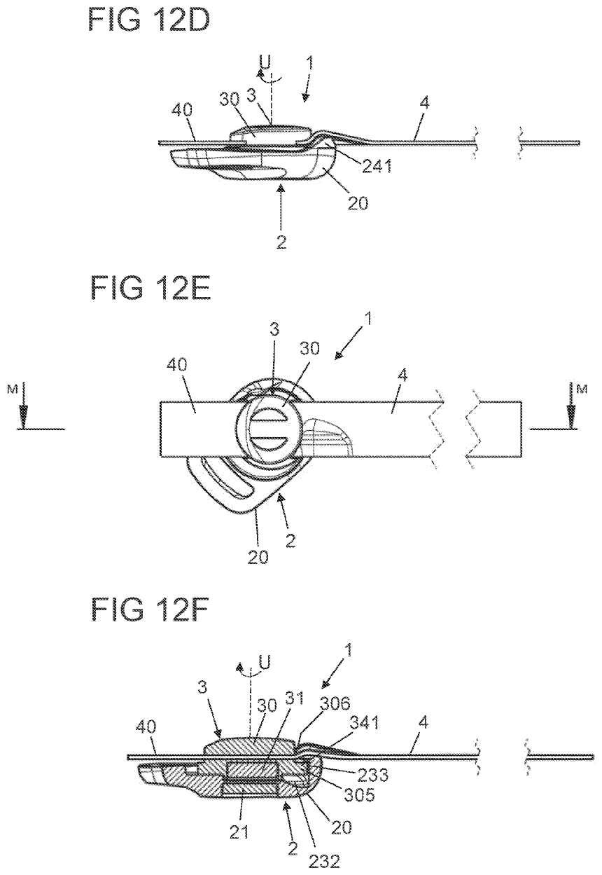

FIGS. 12A to 12F show the connecting device 1 in a rotated position of the second connecting part 3 relative to the first connecting part 2. Here, the second connecting part 3 can be applied to the first connecting part 2 in (any) rotated position, and in any rotated position the engagement section 341 of the second connecting part 3 can be brought into engagement with the engagement protrusions 240, 241 of the first connecting part 2. In the connected position, the second connecting part 3 is twistable relative to the first connecting part 2 along a circumferential direction U about the axis of rotation R while maintaining the engagement of the engagement section 341 with the engagement protrusions 240, 241 and while engaging the blocking element 303 in the recess 231.

Under load, when strap forces act between the straps 4, 5 in the connected position of the connecting device 1, the strap 4 is located between the engagement protrusions 240, 241, as can be seen in FIG. 1. In this case, the engagement protrusions 240, 241 are arranged to the side of the strap 4, so that the strap 4 extends between the engagement protrusions 240, 241 (viewed along the transverse direction Q pointing from engagement protrusion 240 to engagement protrusion 241).

If, on the other hand, the second connecting part 3 is rotated along the circumferential direction U about the axis of rotation R relative to the first connecting part 2, as can be seen from FIGS. 12A to 12F, the strap 4 can extend over one of the engagement protrusions 240, 241, with flexible, flexible deformation of the strap 4, as can be seen in particular from FIGS. 12B and 12D. During twisting, the strap 4 slides (depending on the direction of rotation) onto one of the engagement protrusions 240, 241 and is thereby deformed so that the strap 4 can be moved over the respective engagement protrusion 240, 241.

As can be seen from FIG. 1, for example in conjunction with FIG. 6C, the strap 4 emerges from the fastening section 301 above the base section 300 at an exit line 306, which is curved in accordance with the cylindrical shape of the fastening section 301. Beyond the exit line 306, i.e. outside the fastening section 301, the strap 4 is not connected to the base section 300 in the region of the protruding edge section forming the engagement section 341, but can move freely relative to the base section 300 and, in particular, can be lifted off the base section 300, which enables the deformation of the strap 4 to slide onto the engagement protrusion 240, 241 when the connecting part 3 is twisted relative to the connecting part 2 in a smooth manner.

The exit line 306 is offset radially inwards with respect to the end-face edge section 305 of the base section 300 and is thus spaced radially from the edge section 305. The strap 4 thus emerges from the fastening section 301 along a line that is set back relative to the edge section 305.

From the position shown in FIG. 12A to 12F, the connecting part 3 can also be rotated further. In principle, the connecting part 3 can be rotated through any angle to the connecting part 2.

Under load between the straps 4, 5, the connecting parts 2, 3 automatically move back into the position shown in FIG. 1.

It is also possible to attach or detach the connecting part 3 to or from the connecting part 2 in any rotational position.

In the exemplary embodiment according to FIGS. 1 to 12A-12F, the connecting device 1 implements a strap fastener via which straps can be connected to each other. In the connected position, a load direction determined by the straps is directed essentially along the engagement direction Y.

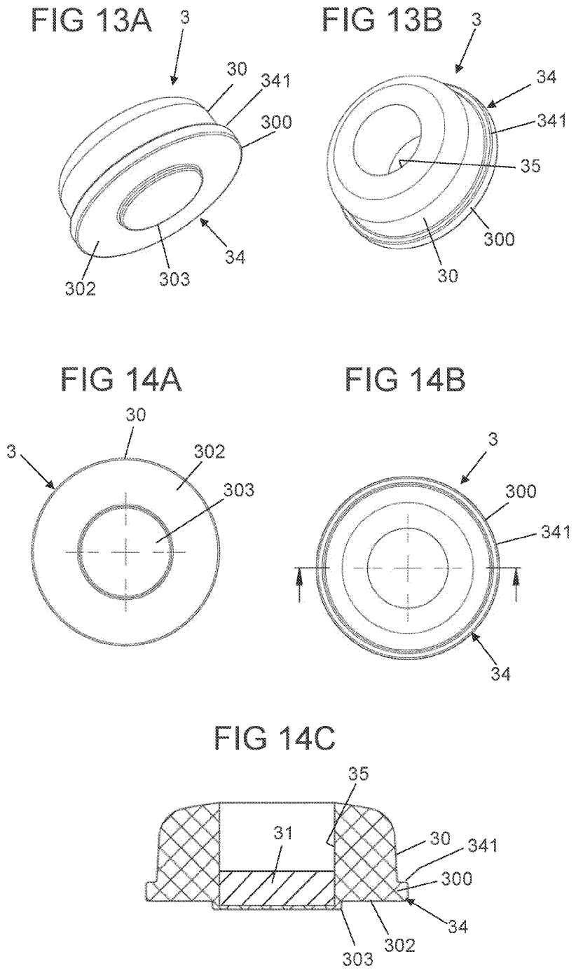

In another exemplary embodiment shown in FIGS. 13A, 13B to 20A-20D, the connecting device 1 is configured as an object fastening device and is used to fasten an object to an associated assembly. The object can, for example, be arranged on a (second) connecting part 3 or integrated into the connecting part 3. In this way, for example, an electrical or electronic device, such as a communication device, a light or the like, can be attached to an associated assembly, such as a helmet or other sports equipment.

In the illustrated exemplary embodiment, the (second) connecting part 3 is rotationally symmetrical in shape and forms a base section 300 arranged on a base body 30, which is circularly cylindrical in shape, as can be seen from FIGS. 13A, 13B and 14A-14C. A base surface 302 is formed on an underside of the base section 300, from which a blocking element 303, which is circular in cross-section and concentric with the base surface 302, protrudes.

A fastening opening 35 for receiving a magnetic device 31 is formed on a housing section that is raised relative to the base section 300.

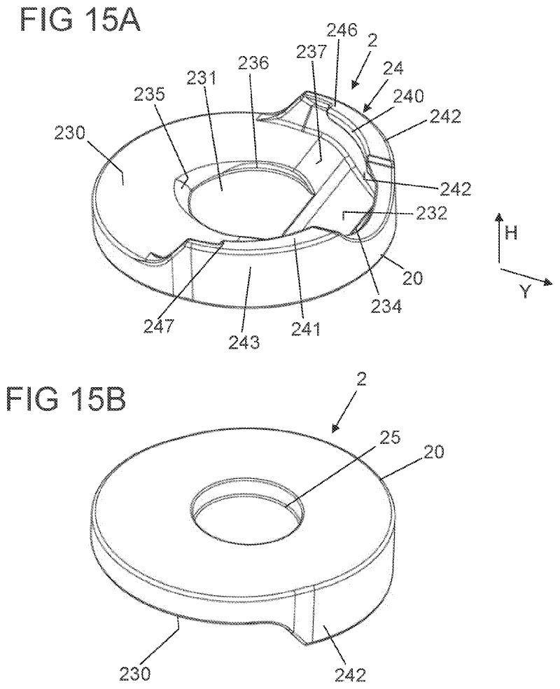

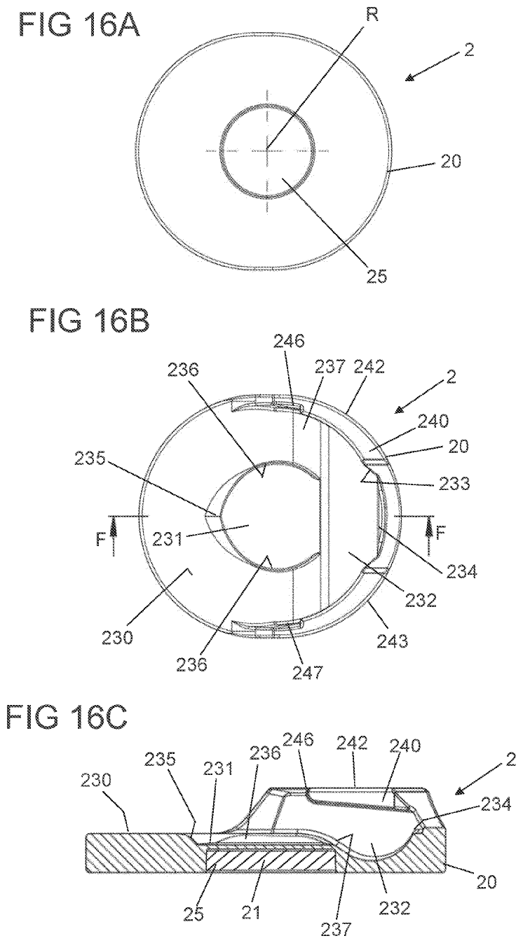

The (second) connecting part 3 shown in FIGS. 13A, 13B and 14A-14C can be attached to a (first) connecting part 2 shown in FIGS. 15A, 15B and 16A-16C, which comprises a base body 20 on which a bottom surface 230 is formed, which extends flatly and evenly on a side of the base body 20 facing the connecting part 3 (when the connecting parts 2, 3 are attached to each other) and with which the base surface 302 comes into flat contact with the base section 300 of the connecting part 3 when the connecting parts 2, 3 are connected to each other.

As has been explained with reference to the exemplary embodiment described above, a recess 231 is formed in the bottom surface 230, which serves to receive the blocking element 303 of the connecting part 3. The bottom surface 230 is also adjoined by an plunge opening 232, which is located between the bottom surface 230 and a support section 233 formed in a front region of the base body 20.

At raised sections 242, 243, engagement protrusions 240, 241 rigidly formed with the base body 20 are disposed above the bottom surface 230 as viewed along a height direction H. In the connected position of the connecting parts 2, 3, an engagement section 341 formed by a circumferential radially protruding edge of the base section 300 of the connecting part 3 is received between the bottom surface 230 and the engagement protrusions 240, 241.

At the rear of the bottom surface 230, the base body 20 forms a fastening opening 25, in which a magnetic device 21 is arranged for magnetic interaction with the magnetic device 31 of the connecting part 3.

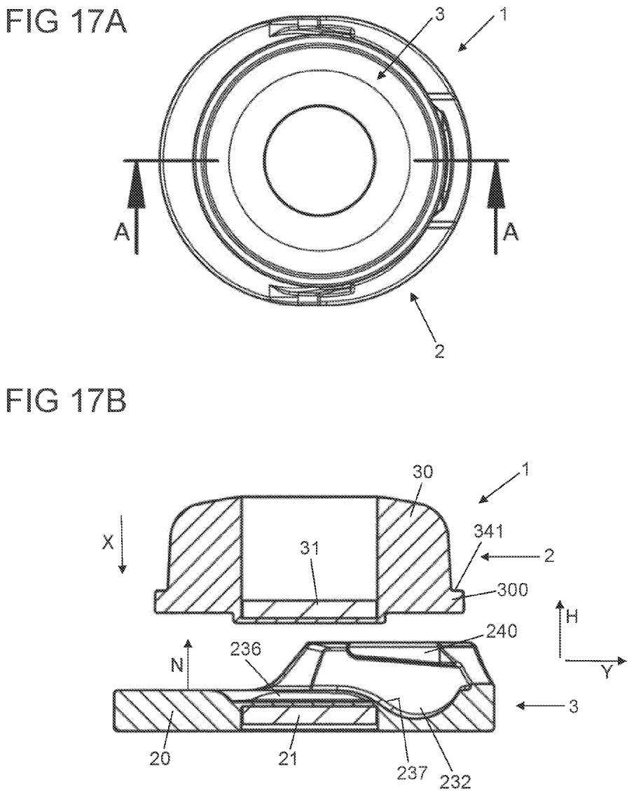

The connecting process of the connecting parts 2, 3, shown in FIGS. 17A, 17B to 20A-20D, is carried out as described above for the exemplary embodiment according to FIGS. 1 to 12A-12F.

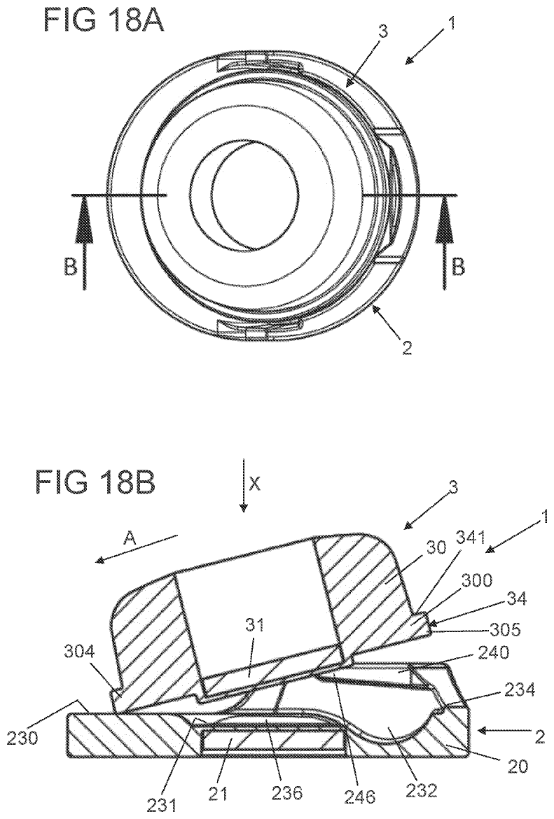

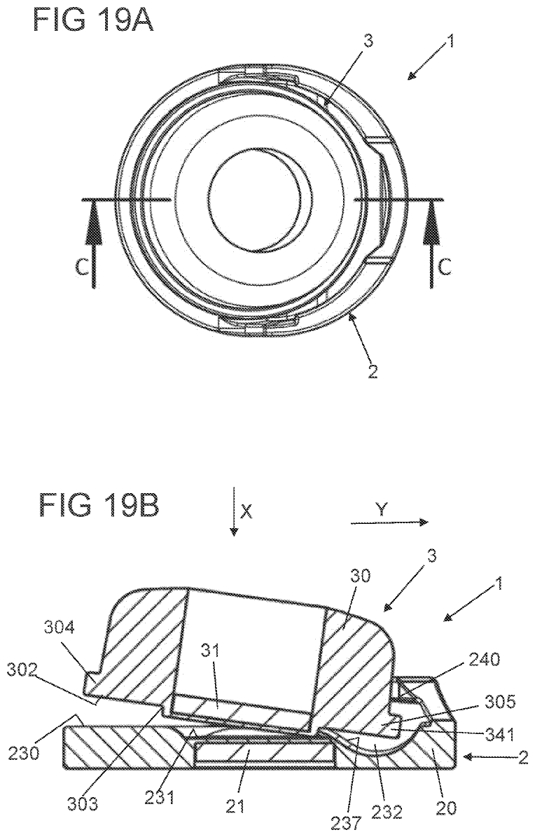

For example, the connecting parts 2, 3 are brought closer together along a closing direction X, which is directed along the height direction H, as can be seen in FIGS. 17A and 17B. The magnetic devices 21, 31 cooperate in a magnetically attracting manner and pull the connecting parts 2, 3 towards each other along the closing direction X, so that the connecting part 3 extends onto the engagement protrusions 240, 241 and slides off at the rear ends 246, 247 of the engagement protrusions 240, 241, as can be seen in FIGS. 18A and 18B. Here, the base section 300 comes into contact with a rear edge section 304 with the bottom surface 230, so that the connecting part 3 slides along a sliding direction A relative to the connecting part 2 and the base section 300 is thus moved along the engagement protrusions 240, 241 until the base section 300 can pass the engagement protrusions 240, 241 and the connecting part 3 is thus brought into the position according to FIGS. 19A, 19B to the connecting part 2 and the blocking section is held above the recess 231 so that the connecting parts 2, 3 do not get caught prematurely.

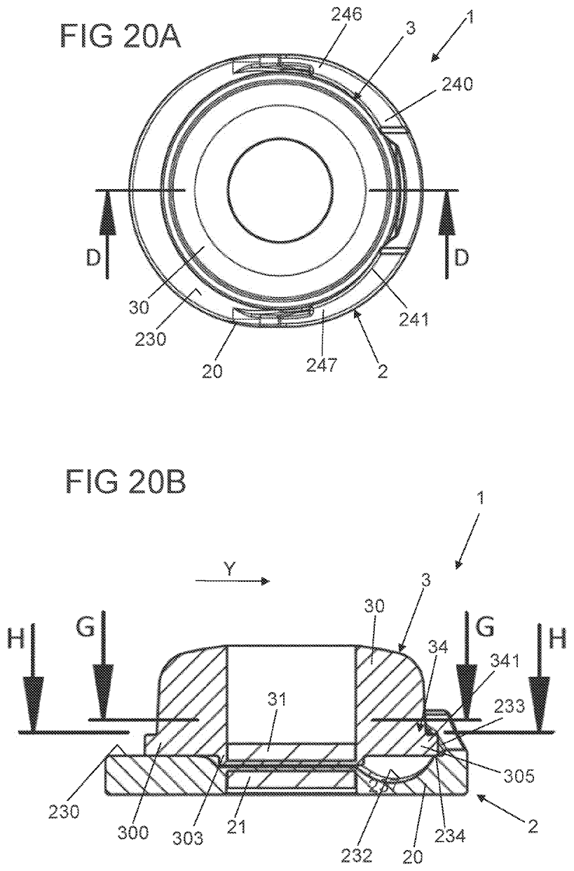

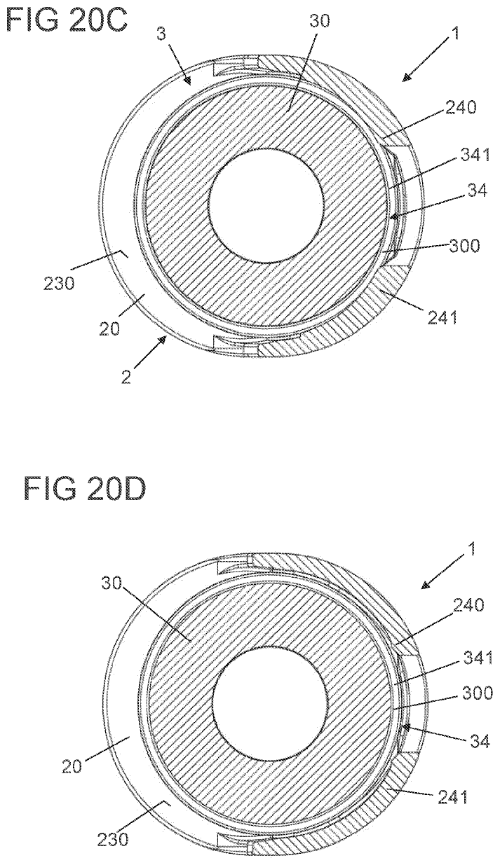

If the base section 300 has been moved past the engagement protrusions 240, 241 along the closing direction X, the engagement section 341 formed on the base section 300 slides in an engagement direction Y into engagement with the (rigid) engagement protrusions 240, 241, as can be seen in the transition from FIGS. 19A, 19B to FIGS. 20A, 20B. In the process, the blocking element 303 slides into the recess 231, magnetically supported by the magnetically attracting effect of the magnetic devices 21, 31.

In the connected position shown in FIGS. 20A-20D, the base section 300 rests with the base surface 302 flat against the bottom surface 230 of the connecting part 2. The blocking element 303 is located in the recess 231. A front edge section 305 of the base section 300 is in contact with the support section 233, wherein the front edge section 305 also rests on a step 234 between the plunge opening 232 and the support section 233, as can be seen in FIG. 19B. Due to the fact that the engagement section 341 formed on the base section 300 engages with the engagement protrusions 240, 241, the connecting part 3 is held on the connecting part 2 in a form-fitting or force-fitting manner, the position of the connecting parts 2, 3 being secured by the magnetic devices 21, 31 and, in addition, disengagement in the opposite direction to the engagement direction Y being blocked by the blocking element 303.

Due to the rotational symmetry of the connecting part 3, the connecting part 3 can be rotated in the connected position on the connecting part 2.

Due to the rotational symmetry, the connecting part 3 can also be arranged in any rotational position on the connecting part 2, which makes it easy and convenient to connect the connecting parts 2 and 3 to each other.

To release the connection 2, 3, the connecting part 3 can be tilted relative to the connecting part 2 in a tilting plane spanned by the closing direction X and the engagement direction Y, with the engagement section 341 formed by the edge of the base section 300 plunging into the plunge opening 232, analogously as can be seen in FIG. 19B. The blocking of the blocking element 303 in the recess 231 is thus released so that the connecting parts 2, 3 can be removed from each other.

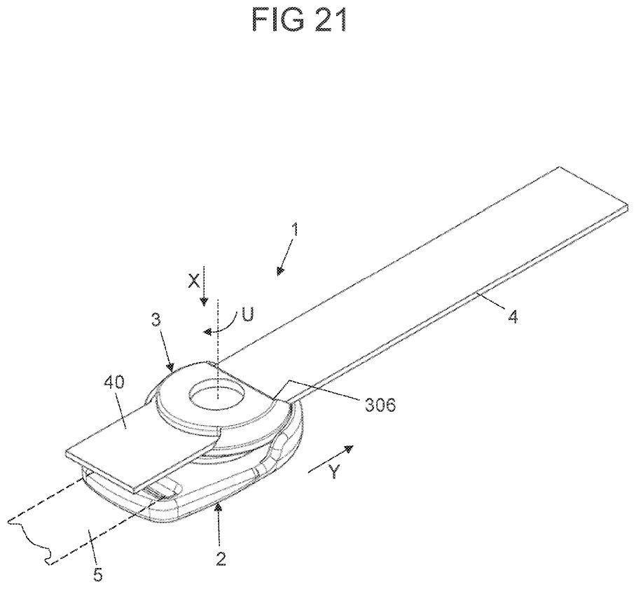

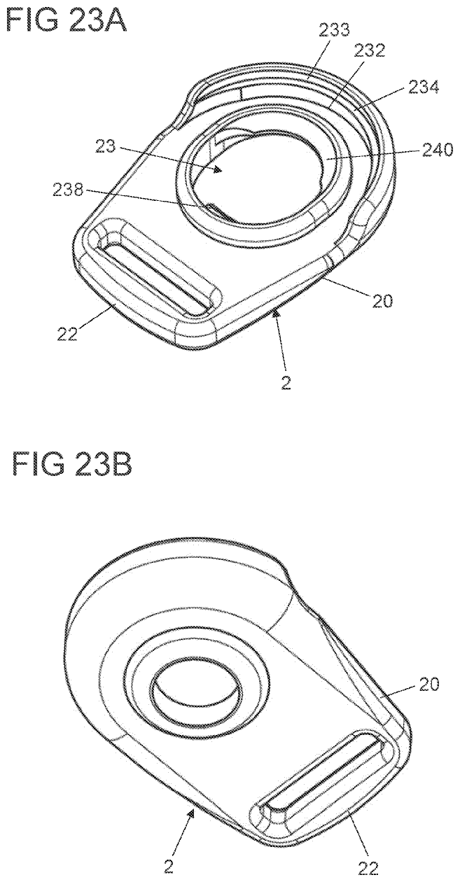

In another exemplary embodiment shown in FIGS. 21 to 30A-30D in the form of a strap fastener, a first connecting part 2 comprises a base body 20 on which a receiving opening 23 is formed. A second connecting part 3 can be attached to the first connecting part 2 by inserting a pin element 340 formed on a base section 300 of a base body 30 of the second connecting part 3 into the receiving opening 23 and bringing it into engagement with an arcuate engagement protrusion 240 on a wall section of the receiving opening 23 of the first connecting part 2 via a circumferential engagement section 341.

In the illustrated exemplary embodiment, a strap 4 is firmly connected to the base body 30 of the connecting part 3 via a fastening section 301 formed on the base section 300. The base section 300 has a circular cylindrical, disk-shaped basic shape and forms a base surface 302 on a side facing the connecting part 2.

The pin element 340 protrudes from the base surface 302, which has a mushroom shape and carries the engagement section 341 extending circumferentially around the closing direction X and implementing an engagement device 34. In the exemplary embodiment shown, the engagement section 341 is thus spatially separated from the base section 300 in that the engagement section 341 is spaced apart from the base section 300 along the closing direction X.

In the illustrated exemplary embodiment, an inclined surface 342 in the form of a conical surface is formed on the engagement section 341, with which the engagement section 341 extends onto the engagement protrusion 240 within the receiving opening 23 when the connecting part 3 is attached to the connecting part 2, so that the connecting part 3 is displaced relative to the connecting part 2 opposite to the engagement direction Y and the engagement section 341 is moved past the engagement protrusion 240 until the engagement section 341 can be brought into engagement with the engagement section 240 in the engagement direction Y.

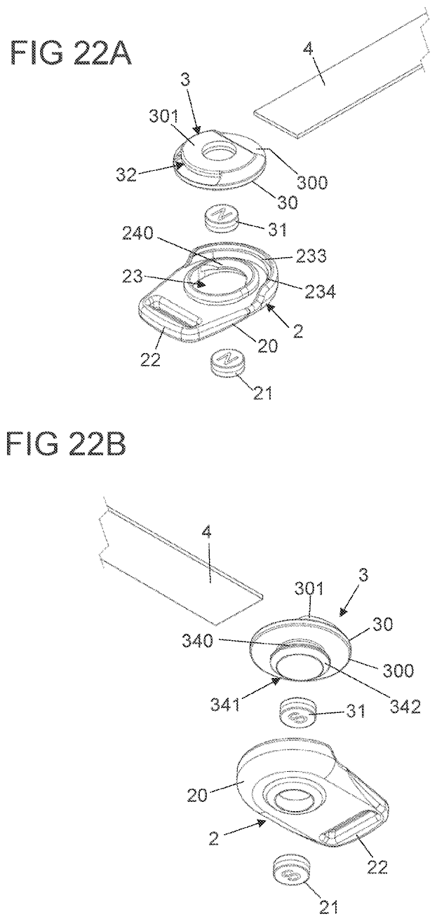

The connecting parts 2, 3 each have a magnetic device 21, 31 (see FIGS. 22A, 22B), which are magnetically attracted to each other along the closing direction X and thus magnetically support the positioning of the connecting parts 2, 3 in the closing direction X.

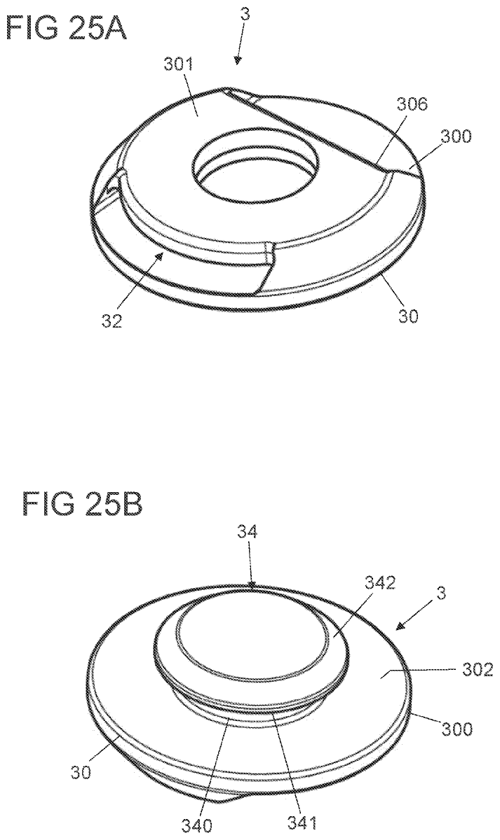

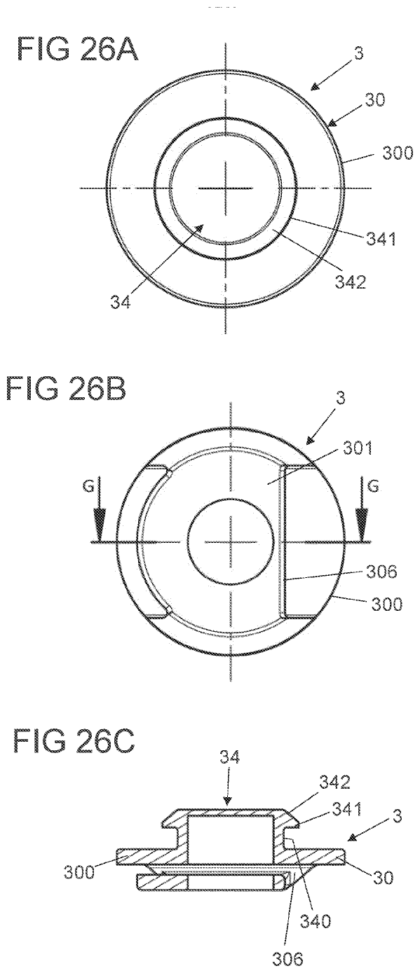

In the illustrated exemplary embodiment, the disk-shaped base section 300 protrudes radially beyond the engagement section 341 on the pin element 340, as can be seen in FIGS. 25A, 25B and 26A, 26B.

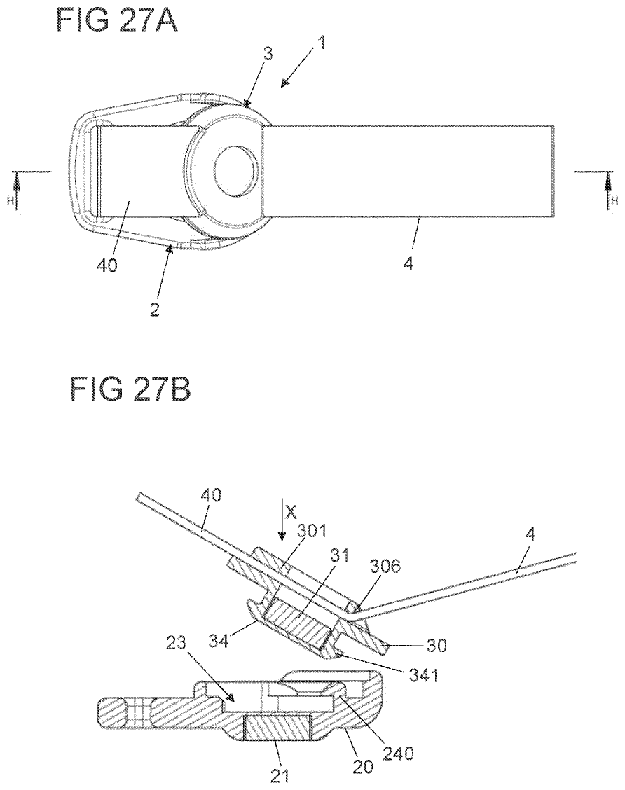

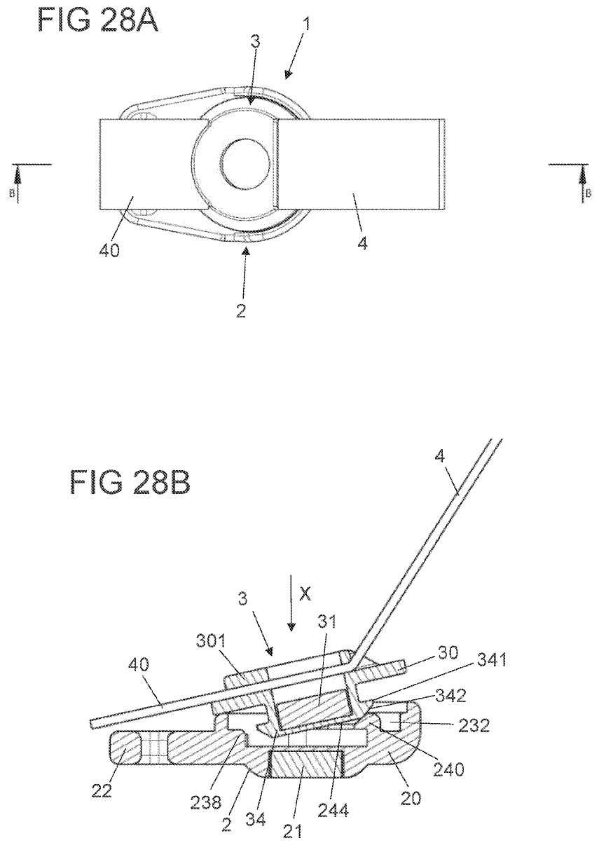

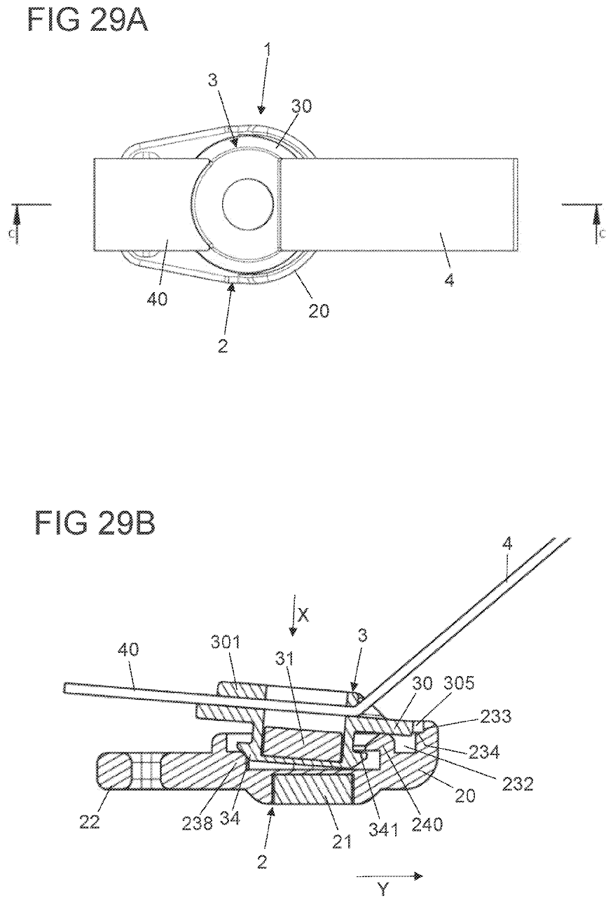

When the connecting parts 2, 3 are placed against each other, shown in the sequence according to FIGS. 27A, 27B to 30A-30D, the connecting part 3 is brought closer to the connecting part 2 in the closing direction X, whereby the connecting part 3 can perform a wobbling movement in such a way that first the engagement section 341 with the inclined surface 342 formed thereon comes into contact with the engagement protrusion 240 in the receiving opening 23, as can be seen from FIG. 28B, and is moved past the engagement protrusion 240 by sliding, as can be seen in the transition from FIGS. 28A, 28B to FIGS. 29A, 29B.

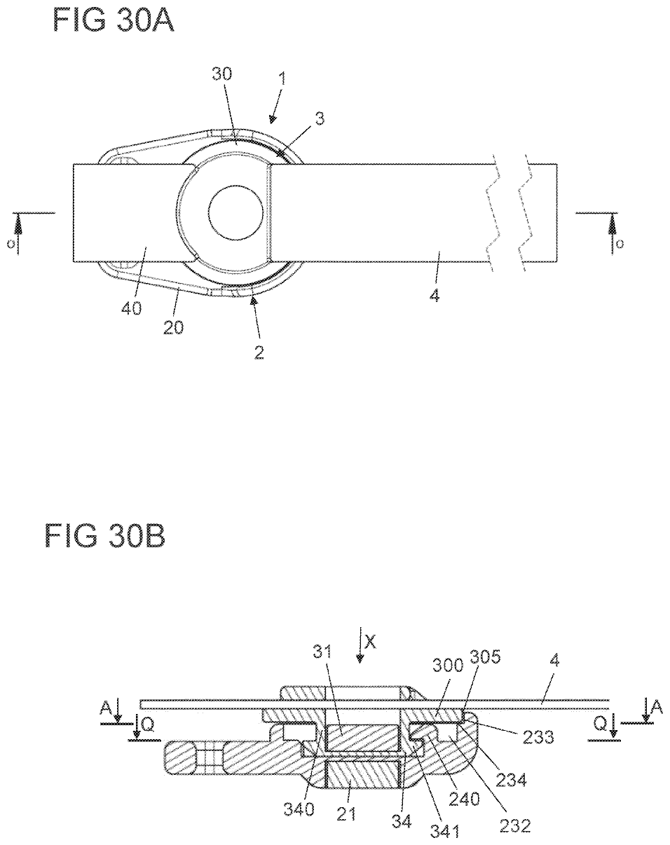

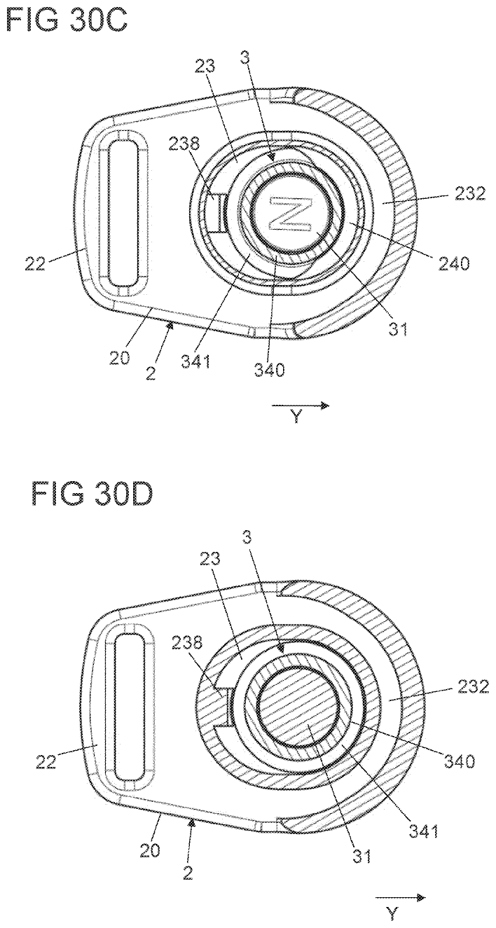

When the engagement section 341 has been moved past the engagement protrusion 240, the engagement section 341 comes into engagement with the engagement protrusion 240 in the engagement direction Y due to magnetic attraction between the magnetic devices 21, 31, so that the connecting parts 2, 3 come into the connected position as shown in FIGS. 30A-30D.

In the connected position, the engagement section 341 on the pin element 340 is in engagement with the arcuately curved engagement protrusion 240 on the wall of the receiving opening 23. On a side facing away from the engagement protrusion 240, the engagement section 341 here faces a blocking section 238 in the form of a protrusion element protruding into the receiving opening 23 in the engagement direction Y. In this way, the blocking section 238 prevents a tangential movement of the pin element 340 in the receiving opening 23 against the engagement direction Y, so that the engagement between the engagement section 341 and the engagement protrusion 240 is blocked.

In the connected position, the base section has a peripheral outer edge section 305 in abutment with a support section 233 which is located in front of the engagement protrusion 240 in the engagement direction Y, as shown in FIG. 30B. A support in the engagement direction Y is thus created on the base section 300 via the support section 233, so that when a load is applied between the connecting parts 2, 3, forces along the load direction corresponding to the engagement direction Y are absorbed and dissipated at the support section 233.

As can also be seen from FIG. 30B, a positive-locking section 234 in the form of a step is formed in the area of the support section 233, on which the base section 300 rests with the edge section 305 in the closing direction X. The step counteracts tilting of the base section 300 and thus of the connecting part 3 relative to the connecting part 2 in order to prevent unintentional loosening of the connecting parts 2, 3 under load.

As can be seen from FIG. 30B in conjunction with FIG. 29B, the step 234 is adjoined by an plunge opening 232, which serves to provide a free space into which the base section 300 can plunge when tilted relative to the connecting section 2, 3, as can be seen from FIG. 29B.

If the connecting parts 2, 3 are to be separated from one another, a user can pull on an actuating section in the form of a tab 40 at the rear of the connecting part 3 and thus lift the pin element 340 out of the receiving opening 23 on a side facing away from the engagement protrusion 240, as can be seen in FIG. 29B. In the process, the base section 300 plunges with a front region facing the support section 233 into the plunge opening 232, which facilitates the tilting of the connecting part 3 relative to the connecting part 2 for releasing the connecting parts 2, 3 from one another.

In the connected position, the support on the step 234 counteracts tilting under load, as in the initial example according to FIGS. 1 to 12A-12F. In this case, a free space is created via the plunge opening 232 in an area adjoining the step 234 in a direction opposite to the engagement direction Y, into which the base section 300 can plunge with its circumferential edge section when the connecting parts 2, 3 are tilted relative to each other to separate the connection.

In the embodiment shown in FIGS. 21 to 30A-30D, the engagement section 341 is not formed on the disk-shaped base section 300, but is formed on the pin element 340 protruding from the base section 300 along the closing direction X, so that the engagement section 341 is spaced apart from the base section 300 along the closing direction X, and furthermore, the circumferential edge section 305 of the base section 300 is disposed radially outside the engagement section 241.

The engagement section 341 is thus spatially separated from the base section 300. In addition, the provision of a positive fit or force fit via the engagement section 341 is functionally separate from the support of the base section 300 on the support section 233 and the positive-locking section 234. This can, for example, favor the support of the base section 300 for load bearing on the support section 233 and also for counteracting tilting via the positive-locking section 234, in that the base section 300 can provide a comparatively large lever arm compared to the engagement section 341 for support.

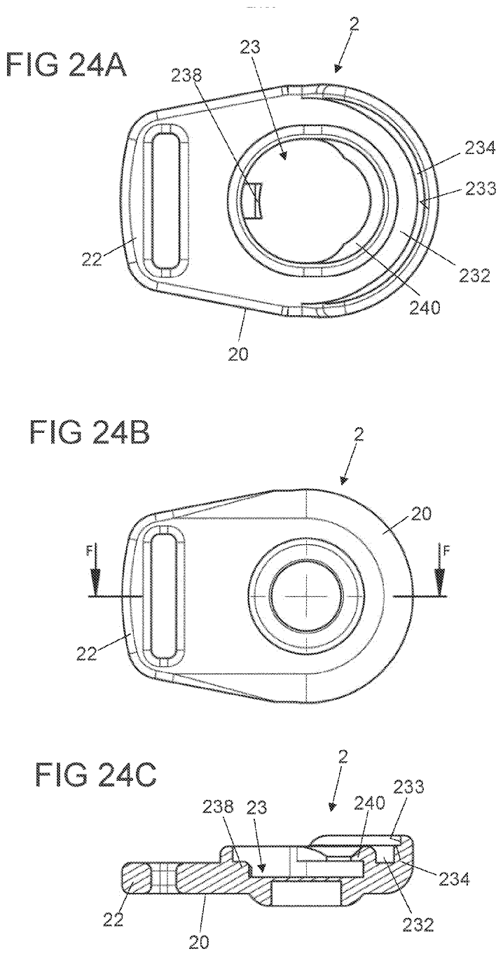

In the embodiment according to FIGS. 21 to 30A-30D, the support section 233 is rigidly formed on the base body 20 of the connecting part 2 by a surface section extending perpendicular to a direction radial to the closing direction X while being arcuately curved about the closing direction X, as shown in FIG. 30B in conjunction with FIG. 24A. Similarly, the positive-locking section 234 in the form of the step is curved in an arcuate manner and thus forms a support for the edge section 305 of the base section 300.

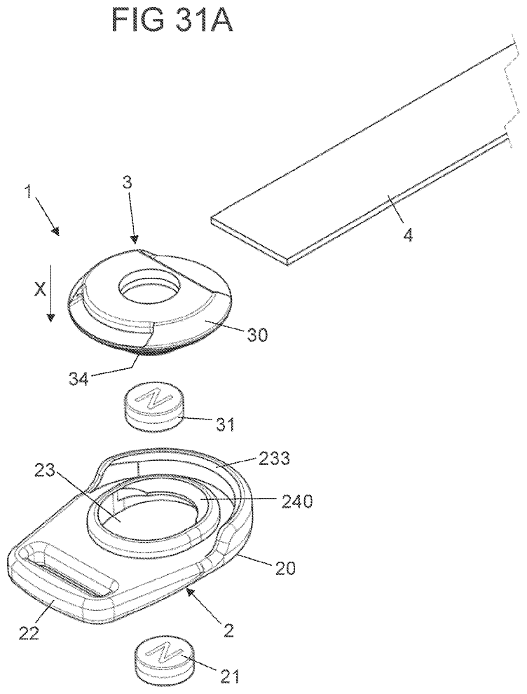

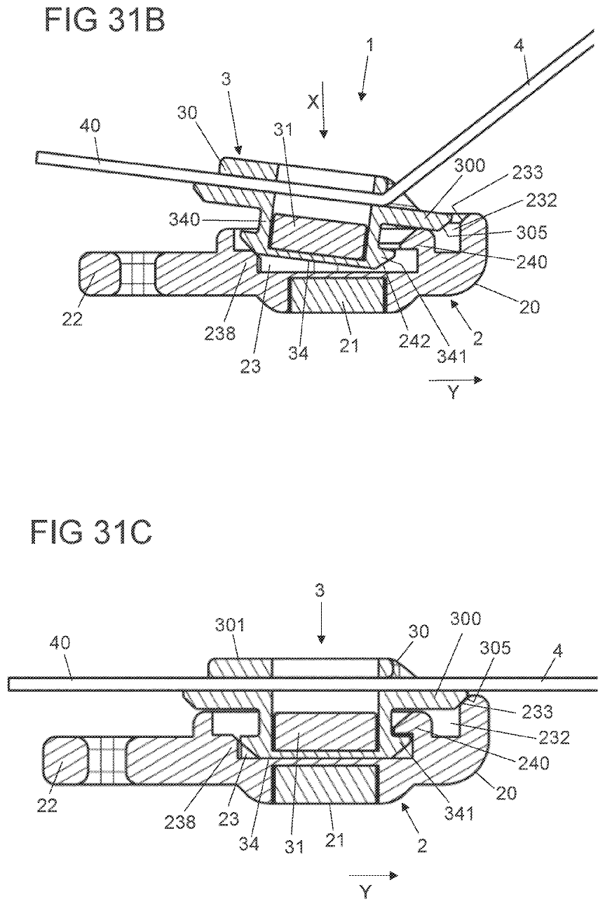

In contrast, in a modified exemplary embodiment shown in FIGS. 31A-31C, an arcuate support section 233 extending obliquely to the closing direction X jointly fulfills the function of the support section 233 and the positive-locking section 234 of the exemplary embodiment shown in FIGS. 31 to 30A-30D. The obliquely extending support section 233 of the exemplary embodiment according to FIGS. 31A-31C forms a support for an oblique edge section 305 of the base section 300 of the connecting part 3, so that both a support in the engagement direction Y and a support against tilting, i.e. against a movement of the base section 300 in the front region in the closing direction X, is created via the support section 233.

The exemplary embodiment according to FIGS. 31A-31C is identical to the exemplary embodiment according to FIGS. 21 to 30A-30D so that reference should also be made to the preceding explanations.

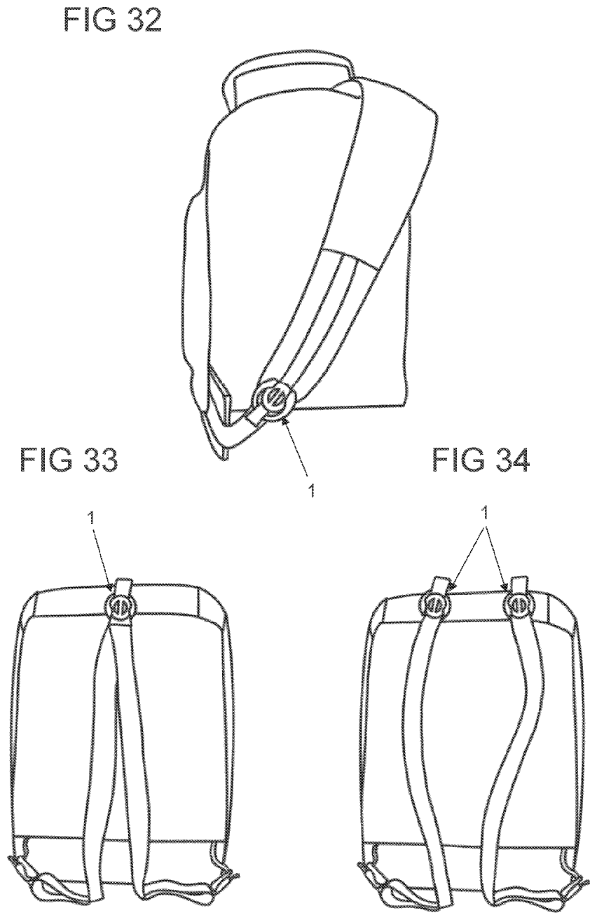

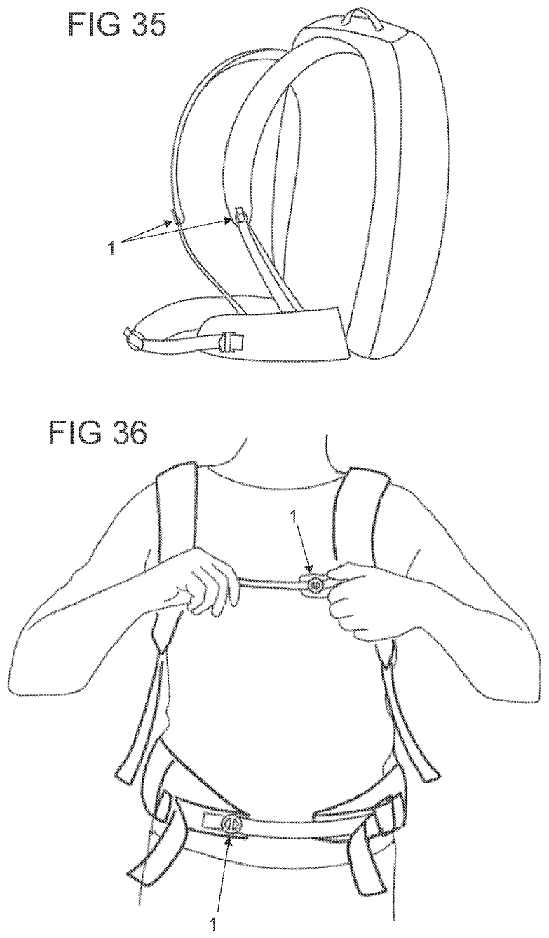

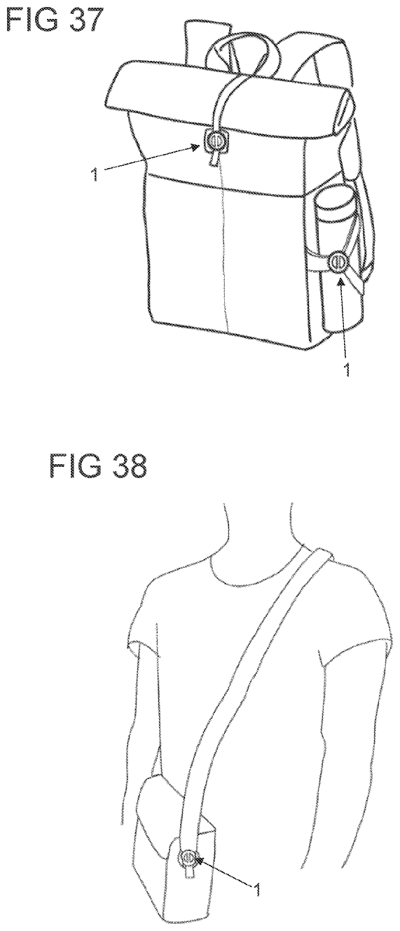

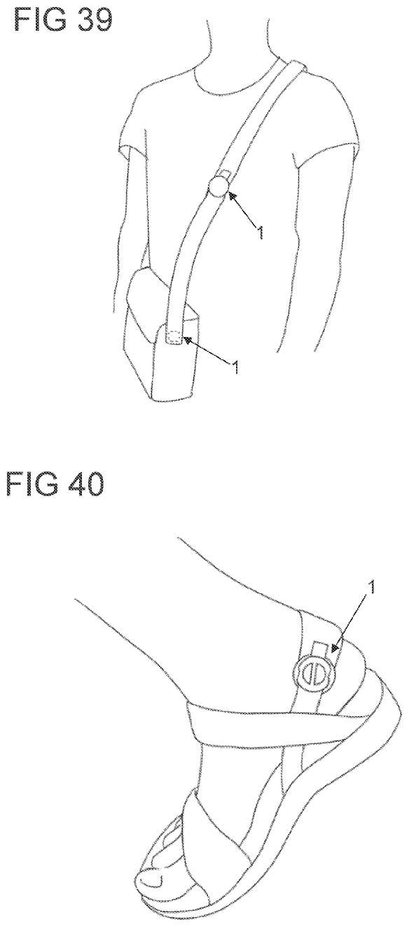

FIGS. 32-58 show exemplary uses of a connecting device 1 as described with reference to the embodiments according to FIGS. 1-31.

A connecting device 1 can be used, for example, on a bag or a rucksack, as shown in FIGS. 32-39. The connecting device 1 can be used to connect strap ends (FIGS. 32, 35, 36 and 39), to connect straps to a bag body (FIGS. 33, 34 and 38) or to close a lid of a bag or rucksack or to attach an object to the bag or rucksack (FIG. 37).

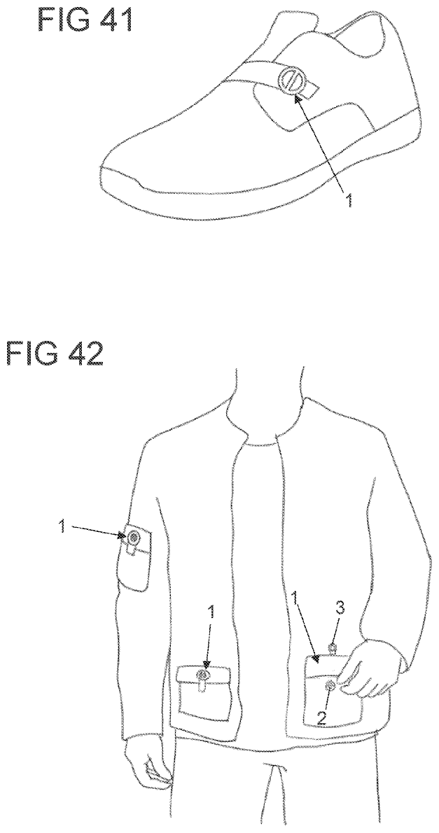

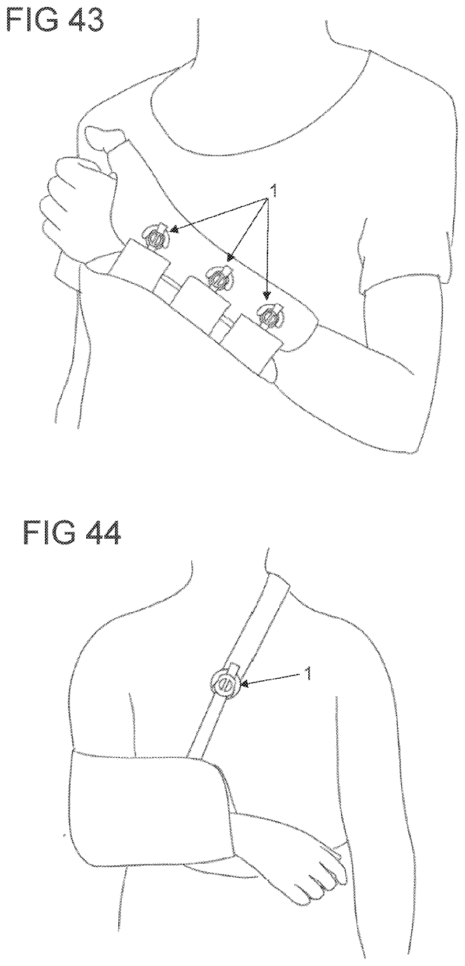

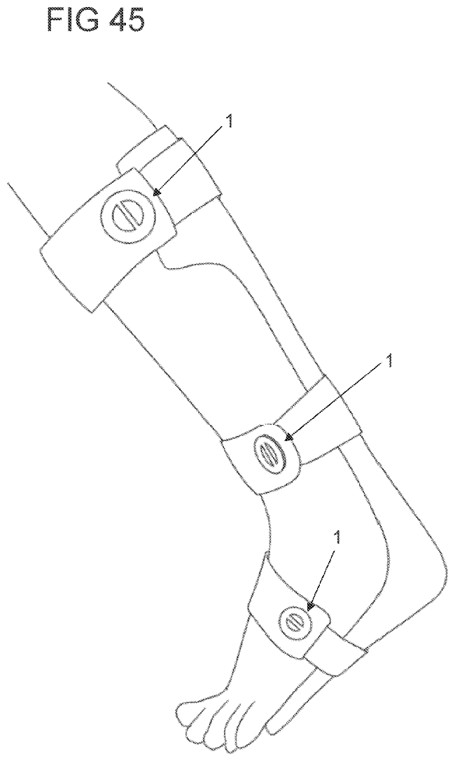

The connecting device 1 can be used as a fastener for a shoe (FIGS. 40 and 41), as a fastener for pockets on a textile item, for example a jacket or vest (FIG. 42), or as a fastener for a medical bandage (FIGS. 43-45).

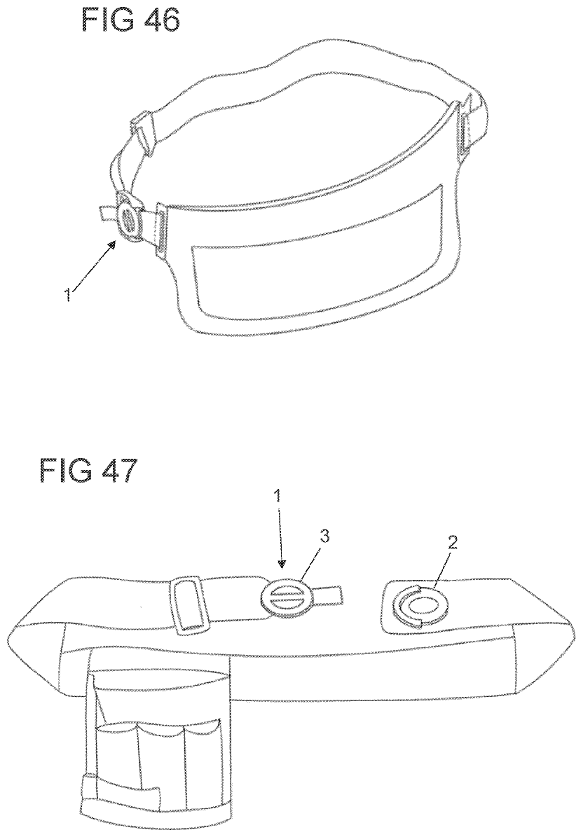

The connecting device 1 can be used as a fastener for a fanny pack (FIG. 46) or for a tool belt (FIG. 47).

The connecting device 1 can also serve as a holder for objects, in particular tools or objects, for example an electronic device, a light or the like, on a belt, in particular a tool belt (FIG. 48).

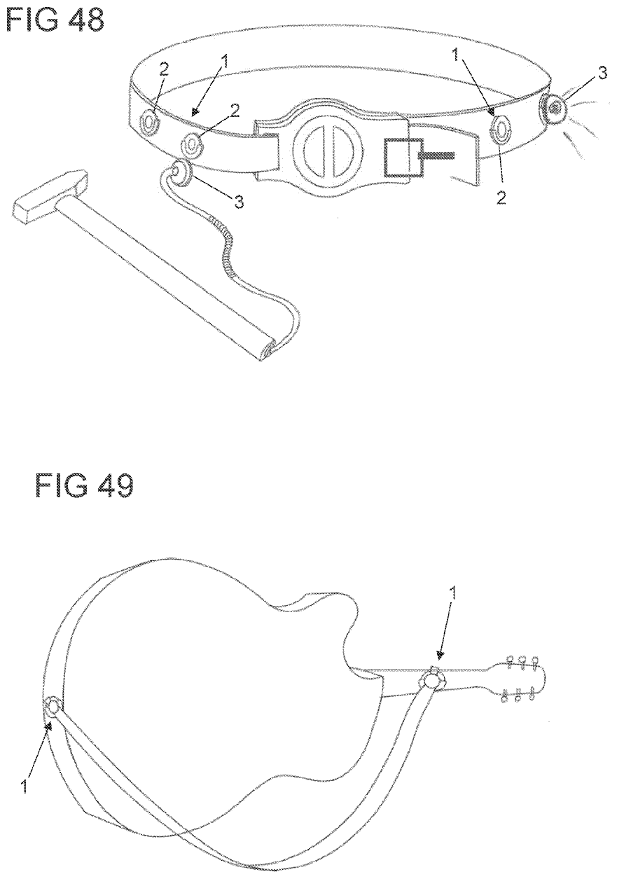

The connecting device 1 can be used as a fastener for a strap on a musical instrument, for example a guitar (FIG. 49).

The connecting device 1 can be used, for example, to attach a strap to a bicycle, for example to a luggage carrier or a basket on a bicycle (FIG. 50).

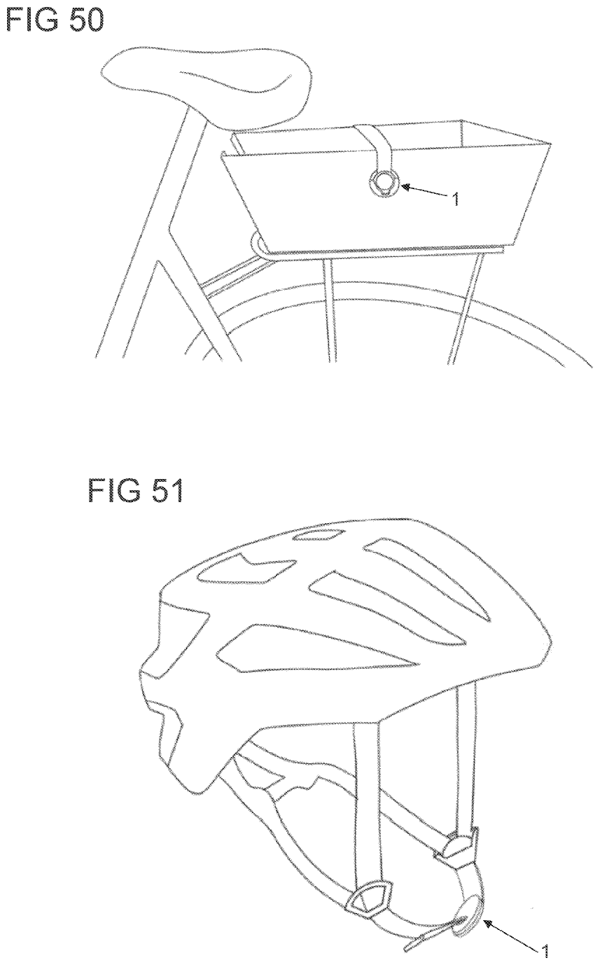

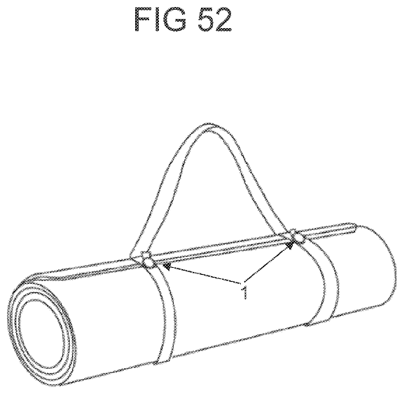

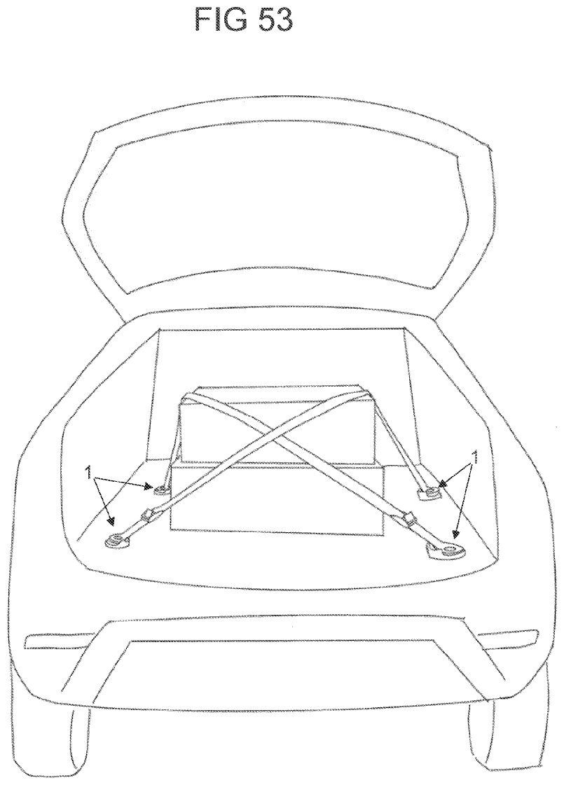

The connecting device 1 can also serve as a fastener for a helmet (FIG. 51).

The connecting device 1 can provide a strap fastener for tying up an object, for example a mat (FIG. 52).

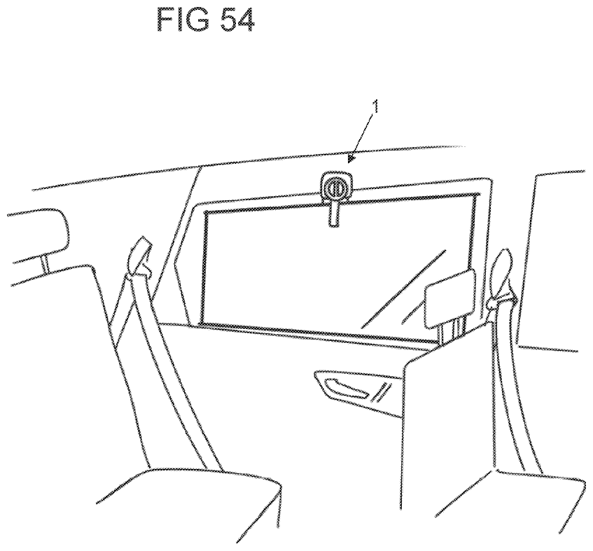

The connecting device 1 can also provide a fastener for a strap system for stowing luggage in a vehicle, for example a car (FIG. 53).

The connecting device 1 can be used as a fastener for an adjustment system in the interior of a vehicle, for example for a sunblind (FIG. 54).

The connecting device 1 can provide a holder for objects on a rack, for example for key rings on a key rack (FIG. 55).

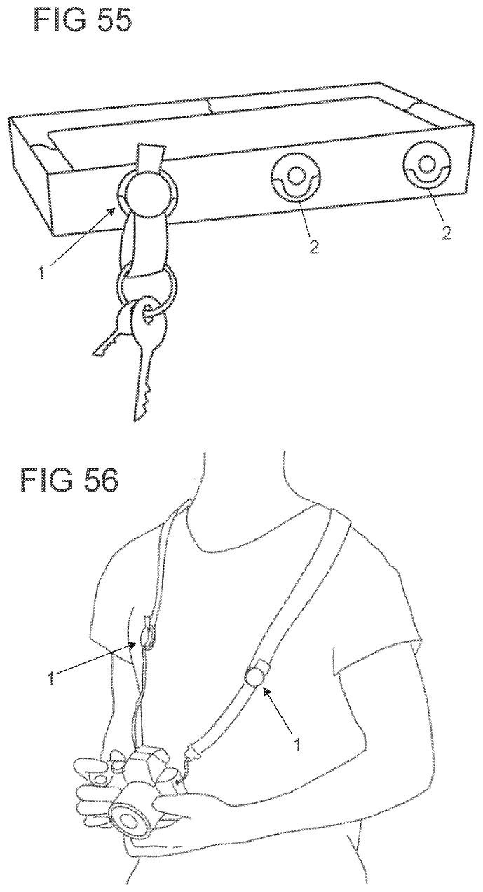

Connecting devices 1 may serve as a holder for a camera, for example to connect the camera to straps (FIG. 56).

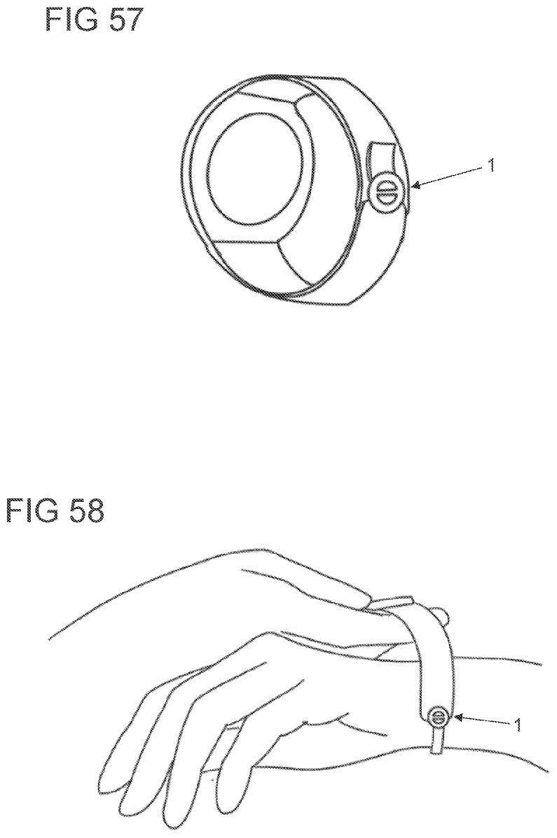

A connecting device 1 may serve as a fastener for a wristwatch (FIG. 57) or a bracelet (FIG. 58).

In all the applications mentioned, the twistability of the connecting parts 2, 3 solves important aspects of the requirements of the respective application. Conventional plug fasteners or closures, which are often used for this type of application, cannot be twisted.

Other applications are conceivable and possible.

The idea underlying the disclosure is not limited to the embodiments shown but can also be implemented in other ways.

In particular, a connecting device of the type described can be used not only as a strap fastener for connecting base ends or as an object fastening device. A connecting device of the type described can be used to connect any number of assemblies.

1. A connecting device, comprising
a first connecting part which comprises has a first base body and at least one engagement protrusion arranged rigidly on the first base body, and
a second connecting part which can be placed against the first connecting part in a closing direction and comprises a second base body with an engagement section arranged rigidly on the second base body, wherein the engagement section is engageable along an engagement direction different from the closing direction (X) with the at least one engagement protrusion of the first connecting part, so that in a connected position of the first connecting part and the second connecting part the engagement section is engaged with the at least one engagement protrusion of the first connecting part,
wherein the first connecting part comprises a first magnetic device and the second connecting part comprises a second magnetic device, wherein the first magnetic device and the second magnetic device cooperate in a magnetically attracting manner to support the attachment of the first connecting part and the second connecting part to one another along the closing direction,
wherein the first base body comprise a positive-locking section against which the second base body abuts in the connected position of the first connecting part and the second connecting part in order to counteract tilting of the second connecting part relative to the first connecting part,
wherein the second base body in the connected position abuts against the first base body in a first region and does not abut against the first base body in a second region adjoining the first region in the engagement direction, so that, viewed along the closing direction, a free space is formed between the first base body and the second base body, and a third region, which is adjacent to or spaced from the second region in the engagement direction, is supported on the positive-locking section.

2. The connecting device according to claim 1, wherein, in a loaded state, when loaded as intended, a load force acts on the second connecting part relative to the first connecting part at least with a directional vector component in the engagement direction.

3. The connecting device according to claim 1, wherein at least one of:
the second base body is configured to approach the first base body with the second region and/or the third region in the closing direction while reducing the free space when the first connecting part and the second connecting part are tilted relative to one another, and
the first base body comprises a plunge opening into which the third region of the second base body plunges when the second connecting part is tilted relative to the first connecting part in the closing direction.

4-5. (canceled)

6. The connecting device according to claim 1, wherein at least one of:
the positive-locking section is formed by a step on which the second base body rests in the connected position,
the positive-locking section is formed by a surface section directed perpendicularly or obliquely to the closing direction,
the positive-locking section, viewed along the closing direction, is spaced apart from the at least one engagement protrusion, and the positive-locking section, viewed along the engagement direction, in spaced apart from the at least one engagement protrusion.

7-9. (canceled)

10. The connecting device according to claim 1, wherein the first base body comprises a support section rigidly formed on the first base body, wherein, in the connected position, the second base body is supported on the support section for receiving a load in the engagement direction.

11. The connecting device according to claim 10, wherein at least one of:
the support section is curved in an arcuate manner around the closing direction,
the support section, viewed along the closing direction, is spaced apart from the at least one engagement protrusion,
the support section, viewed along the engagement direction, is spaced apart from the at least one engagement protrusion, and
the support section is formed by a surface section which is directed parallel or obliquely to the closing direction.

12-14. (canceled)

15. The connecting device according to claim 1, wherein the second connecting part is twistable about the closing direction with respect to the first connecting part in the connected position and the engagement of the engagement section with the at least one engagement protrusion is maintained in the event of a twisting.

16. (canceled)

17. The connecting device according to claim 1, wherein the first connecting part comprises a blocking section which is arranged rigidly on the first base body and is configured to interact with the second connecting part in the connected position in order to block the engagement of the engagement section with the at least one engagement protrusion against the engagement direction, wherein the second connecting part is tiltable relative to the first connecting part in order to release the blocking against the engagement direction in order to separate the first connecting part and the second connecting part from one another and to enable the engagement section and the at least one engagement protrusion to be disengaged.

18. The connecting device according to claim 17, wherein the second connecting part comprises a blocking element arranged rigidly on the second base body for cooperating with the blocking section of the first connecting part.

19. The connecting device according to claim 18, wherein at least one of:
the blocking element, in the connected position, is twistable about the closing direction relative to the blocking section of the first connecting part, wherein, in the event of a twisting, the blocking of the engagement of the engagement section with the at least one engagement protrusion is maintained,
the first base body comprises a recess which is determined at least in sections by the blocking section, wherein the blocking element is arranged in the recess in the connected position so that the engagement of the engagement section with the at least one engagement protrusion is blocked, and
the blocking section comprises a run-up slope, wherein the run-up slope is configured to provide a sliding guide for the blocking element against the engagement direction when the second connecting part is tilted relative to the first connecting part.

20-21. (canceled)

22. The connecting device according to claim 17, wherein at least one of:
the second connecting part can be lifted off the first connecting part for tilting relative to the first connecting part on a side facing away from the at least one engagement protrusion in the opposite direction to the closing direction, and
the second connecting part comprises an actuating section which can be actuated by a user for tilting the second connecting part relative to the first connecting part.

23-24. (canceled)

25. The connecting device according to claim 1, wherein the engagement section extends circumferentially around the closing direction.

26. (canceled)

27. The connecting device according to claim 1, wherein the second base body of the second connecting part comprises a base section which forms the engagement section or to which the engagement section is spaced along the closing direction.

28. The connecting device according to claim 27, wherein at least one of:
the second base body comprises a pin element protruding from the base section along the closing direction, on which the engagement section is arranged and to which the engagement section protrudes along the engagement direction,
the base section protrudes radially beyond the engagement section with respect to the closing direction,
the base section is disc-shaped, and
the base section comprises an edge section, wherein, in the connected position, the edge section of the base section is supported on the positive-locking section.

29-32. (canceled)

33. The connecting device according to claim 27, wherein at least one of:
the base section forms a base surface and the first base body forms a bottom surface, wherein the base surface in the connected position faces the bottom surface along the closing direction, and
for tilting the second connecting part relative to the first connecting part, the base section can be tilted about a tilting axis perpendicular to the closing direction and to the engagement direction relative to the first connecting part.

34. (canceled)

35. The connecting device according to claim 1, wherein the at least one engagement protrusion comprises a sliding slope which extends obliquely with respect to the closing direction and is configured to guide the second connecting part along the closing direction on the at least one engagement protrusion when it is placed against the first connecting part in such a way that the second connecting part is displaced opposite to the engagement direction with respect to the first connecting part and thereby moved past the at least one engagement protrusion and, after moving past in the engagement direction, the engagement section can be brought into engagement with the at least one engagement protrusion.

36. A strap fastener, comprising a connecting device according to claim 1.

37. The strap fastener according to claim 36, comprising a strap which is connected to the second connecting part.

38. The strap fastener according to claim 37, wherein at least one of:
the strap is fixedly and non-adjustably connected to the second connecting part, and
the first connecting part comprises two engagement protrusions which are spaced apart from one another in such a way that the strap can be guided-through between the engagement protrusion in the connected position of the first connecting part and the second connecting part.

39. (canceled)

40. An object fastening device for fastening an object to an assembly, comprising a connecting device according to claim 1, wherein the object is arranged on one of the connecting parts and the other of the connecting parts is arranged on the assembly.
